(19) United States
(12) Patent Application Publication
(10) Pub. No.: US 2010/0129526 A1
(43) Pub. Date: May 27, 2010

(54) SUBSTRATE PROCESSING APPARATUS

(75) Inventors: Shuichi Yasuda, Kyoto (JP); Masashi Kanaoka, Kyoto (JP); Koji Kaneyama, Kyoto (JP); Tadashi Miyagi, Kyoto (JP); Kazuhito Shigemori, Kyoto (JP); Toru Asano, Kyoto (JP); Yukio Toriyama, Kyoto (JP); Takashi Taguchi, Kyoto (JP); Tsuyoshi Mitsuhashi, Kyoto (JP); Tsuyoshi Okumura, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sokudo Co., Ltd., Kyoto (JP)

(21) Appl. No.: 12/698,876

(22) Filed: Feb. 2, 2010

Related U.S. Application Data
(62) Division of application No. 11/295,257, filed on Dec. 6, 2005.

(30) Foreign Application Priority Data
Dec. 6, 2004 (JP) 2004-353121
Mar. 29, 2005 (JP) 2005-095779
Jul. 26, 2005 (JP) 2005-216158

(51) Int. Cl. B05D 5/12

(52) U.S. Cl. 427/58

(57) ABSTRACT

A method of processing a substrate in a substrate processing apparatus that is arranged adjacent to an exposure device and includes first, second and third processing units, includes the steps of forming a film made of a photosensitive material on the substrate by said first processing unit before exposure processing by said exposure device. The method also includes applying drying processing to the substrate by said second processing unit after the exposure processing by said exposure device and applying development processing to the substrate by said third processing unit after the drying processing by said second processing unit

### CROSS-REFERENCES TO RELATED APPLICATIONS

This application is a division of U.S. patent application Ser. No. 11/295,257, filed Dec. 6, 2005, which claims priority to Japanese Patent Application No. 2004-353121, filed Dec. 6, 2004, Japanese Patent Application 2005-095779, filed Mar. 29, 2005, and Japanese Patent Application No. 2005-216158, filed on Jul. 26, 2005. The disclosures of Ser. No. 11/295,257, JP 2004-353121, 2005-095779, and JP 2005-216158 are hereby incorporated by reference in their entirety for all purposes.

The present application is related to the following four applications filed Dec. 6, 2005, and commonly owned: 1) U.S. patent application Ser. No. 11/294,877, entitled “SUBSTRATE PROCESSING APPARATUS AND SUBSTRATE PROCESSING METHOD,” 2) U.S. patent application Ser. No. 11/294,727, entitled “SUBSTRATE PROCESSING APPARATUS,” and 3) U.S. patent application Ser. No. 11/295,240, entitled “SUBSTRATE PROCESSING APPARATUS AND SUBSTRATE PROCESSING METHOD,” and 4) U.S. patent application Ser. No. 11/295,216, entitled “SUBSTRATE PROCESSING APPARATUS.”

### BACKGROUND OF THE INVENTION

1. Field of the Invention

The present invention relates to substrate processing apparatuses for applying processing to substrates.

2. Description of the Background Art

A substrate processing apparatus is used to apply a variety of processings to substrates such as semiconductor substrates, substrates for use in liquid crystal displays, plasma displays, optical disks, magnetic disks, magneto-optical disks, photomasks, and other substrates.

Such a substrate processing apparatus typically applies a plurality of successive processings to a single substrate. The substrate processing apparatus as described in JP 2003-324139 A comprises an indexer block, an anti-reflection film processing block, a resist film processing block, a development processing block, and an interface block. An exposure device is arranged adjacent to the interface block as an external device separate from the substrate processing apparatus.

In the above-described substrate processing apparatus, a substrate is carried from the indexer block into the anti-reflection film processing block and the resist film processing block, where the formation of an anti-reflection film and resist film coating processing are applied to the substrate. The substrate is then carried to the exposure device through the interface block. After exposure processing has been applied to the resist film on the substrate by the exposure device, the substrate is transported to the development processing block through the interface block. In the development processing block, development processing is applied to the resist film on the substrate to form a resist pattern thereon, and the substrate is subsequently carried into the indexer block.

With recent improvements in the density and integration of devices, making finer resist patterns have become very important. Conventional exposure devices typically perform exposure processing by providing reduction projection of a reticle pattern on a substrate through a projection lens. With such conventional exposure devices, however, the line width of an exposure pattern is determined by the wavelength of the light source of an exposure device, thus making it impossible to make a resist pattern finer than that.

For this reason, a liquid immersion method is suggested as a projection exposure method allowing for finer exposure patterns (refer to, e.g., WO99/49504 pamphlet). In the projection exposure device according to the WO99/49504 pamphlet, a liquid is filled between a projection optical system and a substrate, resulting in a shorter wavelength of exposure light on a surface of the substrate. This allows for a finer exposure pattern.

However, in the projection exposure device according to the aforementioned WO99/49504 pamphlet, exposure processing is performed with the substrate and the liquid being in contact with each other. Accordingly, the substrate to which the liquid adheres is transported out of the exposure device. Thus, when combining the substrate processing apparatus according to the aforementioned JP 2003-324139 A with the exposure device using the liquid immersion method as described in the aforementioned WO99/49504 pamphlet as an external device, the liquid adhering to the substrate that has been carried out of the exposure device may drop in the substrate processing apparatus, causing operational troubles such as abnormalities in the electric system of the substrate processing apparatus.

There is also a possibility that the substrate is contaminated by, e.g., residual droplets after the exposure processing and the eluate from an organic film on the substrate, causing processing defects of the substrate in subsequent processing steps.

### SUMMARY OF THE INVENTION

It is an object of the present invention to provide a substrate processing apparatus in which operational troubles due to a liquid attached to a substrate in an exposure device are prevented.

Another object of the present invention is to provide a substrate processing apparatus in which processing defects of a substrate due to the contamination after exposure processing are prevented.

(1)

A substrate processing apparatus according to one aspect of the present invention that is arranged adjacent to an exposure device comprises a processing section for applying processing to a substrate, and an interface that is provided on one end of the processing section for exchanging the substrate between the processing section and the exposure device, wherein the processing section comprises a first processing block that includes the first processing unit that forms a photosensitive film made of a photosensitive material on the substrate, a first thermal processing unit that thermally treats the substrate, and a first transport unit that transports the substrate, a second processing block that includes a second processing unit that applies drying processing to a substrate after the exposure processing by the exposure device, a second thermal processing unit that thermally treats the substrate, and a second transport unit that transports the substrate, and a third processing block that includes a third processing unit that applies development processing to the substrate after the drying processing by the second processing unit, a third thermal processing unit that thermally treats the substrate, and a third transport unit that transports the substrate, wherein the second processing block is arranged adjacent to the interface.

In the substrate processing apparatus, the photosensitive film made of a photosensitive material is formed on the substrate by the first processing unit in the first processing block. Then, the substrate is transported to the first thermal processing unit by the first transport unit, where the substrate is subjected to given thermal treatment. Then, the substrate is transported to the exposure device from the processing section through the interface, where the substrate is subjected to the exposure processing. The substrate after the exposure processing is transported to the second processing block from the exposure device through the interface.

Next, in the second processing block, the substrate is subjected to the drying processing by the second processing unit. Then, the substrate is transported from the second processing unit to the second thermal processing unit, the substrate is subjected to given thermal treatment by the second thermal processing unit. The substrate is subsequently transported to an adjacent other processing block by the second transport unit.

Next, in the third processing block, the substrate is subjected to the development processing by the third processing unit. The substrate is subsequently transported to the third thermal processing unit by the third transport unit, and subjected to given thermal treatment by the third thermal processing unit. Then, the substrate is transported to an adjacent other processing block by the third transport unit.

In this way, the substrate after the exposure processing is subjected to the drying processing by the second processing unit. The second processing block is arranged adjacent to the interface, which allows the drying processing to be applied to the substrate immediately after the exposure processing. For this reason, even if a liquid is attached to the substrate in the exposure device, it is possible to prevent the liquid from dropping in the substrate processing apparatus. As a result, in the substrate processing apparatus, operational troubles such as abnormalities in the electric system are prevented. In addition, drying the substrate prevents particles and the like in the atmosphere from attaching to the substrate, which prevents contamination of the substrate. This allows processing defects of the substrate to be reduced.

In addition, during the transport of substrate after the drying processing to the third processing unit, the component of the photosensitive material on the substrate can be reliably prevented from being eluted in the liquid remaining on the substrate. This prevents an exposure pattern formed on the substrate from deformation. As a result, processing defects of the substrate during the development processing in the third processing unit are prevented.

Furthermore, the substrate processing apparatus has the structure in which the second processing block is added to an existing substrate processing apparatus having the first and third processing blocks. Thus, operational troubles of substrate the processing apparatus and processing defects of the substrate can be reduced at low cost.

(2)

The second processing unit may dry the substrate by supplying an inert gas onto the substrate. The use of the inert gas prevents a chemical influence upon a film on the substrate while drying the substrate reliably.

(3)

The processing section may comprise a fourth processing block that includes a fourth processing unit that forms of an anti-reflection film on the substrate before the formation of a photosensitive film by the first processing unit, a fourth thermal processing unit that thermally treats the substrate, and a fourth transport unit that transports the substrate.

In this case, the anti-reflection film is formed on the substrate by the fourth processing unit, thus, potential standing waves and halation generated during the exposure processing can be reduced. This can reduce further processing defects of the substrate during the exposure processing.

(4)

The substrate processing apparatus may further comprise an indexer that is arranged on another end of the processing section and carries in and out the substrate to and from the processing section, wherein the fourth processing block may be arranged adjacent to the indexer. In this case, the anti-reflection film is formed on the substrate immediately after that transported to the processing section by the fourth processing unit, and then the photosensitive film is subsequently formed by the first processing unit. This allows the anti-reflection film and the photosensitive film on the substrate to be formed smoothly.

(5)

The interface may further include a fifth processing unit that applies given processing to the substrate, a platform on which the substrate is temporarily mounted, a fifth transport unit that transports the substrate between the processing section, the fifth processing unit, and the platform, and a sixth transport unit that transports the substrate between the platform, the exposure device, and the second processing unit, and wherein the sixth transport unit may transport the substrate that has been carried out of the exposure device to the second processing unit.

In this case, the substrate is subjected to the given processing by the processing section, and then transported to the fifth processing unit by the fifth transport unit. After the substrate is subjected to the given processing by the fifth processing unit, the substrate is transported onto the platform by the fifth transport unit. Then, the substrate is transported from the platform into the exposure device by the sixth transport unit. After the substrate is subjected to the exposure processing by the exposure device, the substrate is transported to the second processing unit by the sixth transport unit. The substrate is dried by the second processing unit, and then transported onto the platform by the sixth transport unit. After this, the substrate is subsequently transported from the platform onto the processing section by the fifth transport unit.

In this way, the substrate after the exposure processing is dried by the second processing unit, and then transported onto the platform. For this reason, even if a liquid is attached to the substrate in the exposure device, it is possible to prevent the liquid from dropping in the substrate processing apparatus. As a result, operational troubles of the substrate processing apparatus are prevented.

In addition, the disposition of the fifth processing unit in the interface and the transport of the substrate by the two transport units enables the addition of processing contents without increasing the footprint of the substrate processing apparatus.

(6)

The sixth transport unit may include a first holder and a second holder each for holding the substrate, the sixth transport unit may hold the substrate with the first holder during the transport of the substrate from the platform to the exposure device and from the second processing unit to the platform, and the sixth transport unit may hold the substrate with the second holder during the transport of the substrate from the exposure device to the second processing unit.

In this way, the first holder is used during the transport of the substrate to which a liquid is not attached before the exposure processing and after the drying processing, while the second holder is used during the transport of the substrate to which a liquid is attached immediately after the exposure processing. This prevents the liquid from attaching to the first holder, which prevents the liquid from attaching to the substrate before the exposure processing. This prevents the particles and the like in the atmosphere from adhering to the substrate, which prevents contaminations of the exposure device. As a result, processing defects of the substrate in the exposure device can be reduced.

(7)

The second holder may be provided below the first holder. In this case, even if a liquid drops from the second holder and the substrate held thereon, the liquid will not attach to the first holder and the substrate held thereon. The liquid is thus reliably prevented from attaching to the substrate after the drying processing and before the exposure processing.

(8)

The fifth processing unit may include an edge exposure unit for subjecting a peripheral portion of the substrate to exposure processing. The peripheral portion of the substrate is thus subjected to exposure by the edge exposure unit.

(9)

The second processing unit may further apply the cleaning processing to the substrate before the drying processing to the substrate.

In this case, even if a liquid attaches to the substrate during exposure, and particles and the like in the atmosphere attach to the substrate while being transported from the exposure device to the second processing unit, the deposits can be removed reliably. This prevents processing defects of the substrate reliably.

(10)

The second processing unit may comprise a substrate holding device that holds the substrate substantially horizontally, a rotation-driving device that rotates the substrate held on the substrate holding device about an axis vertical to the substrate, a cleaning liquid supplier that supplies a cleaning liquid onto the substrate held on the substrate holding device, and an inert gas supplier that supplies an inert gas onto the substrate after the cleaning liquid has been supplied onto the substrate by the cleaning liquid supplier.

In the second processing unit, the substrate is held on the substrate holding device substantially horizontally, and the substrate is rotated about the axis vertical to the substrate by the rotation-driving device. Then, the cleaning liquid is supplied onto the substrate from the cleaning liquid supplier, followed by the supply of the inert gas from the inert gas supplier.

In this case, since the substrate is rotated as the cleaning liquid is supplied onto the substrate, the cleaning liquid on the substrate moves toward the peripheral portion of the substrate by the centrifugal force and splashed away. This reliably prevents the deposits of particles and the like removed by the cleaning liquid from remaining on the substrate. In addition, since the substrate is rotated as the inert gas is supplied onto the substrate, the cleaning liquid remaining on the substrate after the cleaning of the substrate is efficiently removed. This reliably prevents the deposits of particles and the like from remaining on the substrate and the substrate is dried reliably. This reliably prevents the component of the photosensitive material from being eluted in the liquid attached to the substrate during the transport of the substrate after the drying processing to the third processing unit. This reliably prevents the deformation of the exposure pattern formed on the photosensitive film. As a result, processing defects of the substrate during the development processing in the third processing unit are reliably prevented.

(11)

The inert gas supplier may supply the inert gas so that the cleaning liquid supplied onto the substrate by the cleaning liquid supplier is removed from the substrate as the cleaning liquid moves outwardly from the center of the substrate.

This prevents the cleaning liquid from remaining on the center of the substrate, thus reliably preventing the generation of dry marks (dry stains) on a surface of the substrate. In addition, this reliably prevents the component of the photosensitive material from being eluted in the liquid attached to the substrate during the transport of the substrate after the drying processing to the third processing unit. This reliably prevents the deformation of the exposure pattern formed on the photosensitive film. As a result, processing defects of the substrate during the development processing in the third processing unit are reliably prevented.

(12)

The second processing unit may further comprise a rinse liquid supplier that supplies a rinse liquid onto the substrate after the supply of the cleaning liquid by the cleaning liquid supplier and before the supply of the inert gas by the inert gas supplier.

This allows the cleaning liquid to be reliably cleaned away by the rinse liquid, thus reliably preventing the deposits of particles and the like from remaining on the substrate.

(13)

The inert gas supplier may supply the inert gas so that the rinse liquid supplied onto the substrate by the rinse liquid supplier is removed from the substrate as the rinse liquid moves outwardly from the center of the substrate.

This prevents the rinse liquid from remaining on the center of the substrate, thus reliably preventing the generation of dry marks on the surface of the substrate. In addition, this reliably prevents the component of the photosensitive material from being eluted in the liquid attached to the substrate during the transport of the substrate after the drying processing to the third processing unit. This reliably prevents the deformation of the exposure pattern formed on the photosensitive film.

(14)

A substrate processing apparatus according to another aspect of the present invention that is arranged adjacent to an exposure device comprises a processing section for applying processing to a substrate, and an interface that is provided on one end of the processing section for exchanging the substrate between the processing section and the exposure device, wherein the processing section comprises a first processing block that includes the first processing unit that forms a photosensitive film made of a photosensitive material on the substrate, a first thermal processing unit that thermally treats the substrate, and a first transport unit that transports the substrate, a second processing block that includes a second processing unit that cleans the substrate with a fluid nozzle that supplies a fluid mixture containing a liquid and a gas onto the substrate after the exposure processing by the exposure device, a second thermal processing unit that thermally treats the substrate, and a second transport unit that transports the substrate; and a third processing block that includes a third processing unit that applies development processing to the substrate after the cleaning processing by the second processing unit, a third thermal processing unit that thermally treats the substrate, and a third transport unit that transports the substrate, wherein the second processing block is arranged adjacent to the interface.

In the substrate processing apparatus, the photosensitive film made of a photosensitive material is formed on the substrate by the first processing unit in the first processing block. Then, the substrate is transported to the first thermal processing unit by the first transport unit, where the substrate is subjected to given thermal treatment. Then, the substrate is transported to the exposure device from the processing section through the interface, where the substrate is subjected to the exposure processing. The substrate after the exposure processing is transported to the second processing block from the exposure device through the interface.

Next, in the second processing block, the substrate is subjected to the cleaning processing by the second processing unit. Then, the substrate is transported from the second processing unit to the second thermal processing unit, the substrate is subjected to given thermal treatment by the second thermal processing unit. The substrate is subsequently transported to an adjacent other processing block by the second transport unit.

Next, in the third processing block, the substrate is subjected to the development processing by the third processing unit. The substrate is subsequently transported to the third thermal processing unit by the third transport unit, and subjected to given thermal treatment by the third thermal processing unit. Then, the substrate is transported to an adjacent other processing block by the third transport unit.

In this way, the substrate after the exposure processing is subjected to the cleaning processing by the second processing unit. The fluid mixture containing a gas and a liquid is supplied onto the substrate from the fluid nozzle in the second processing unit.

Since the fluid mixture discharged from the fluid nozzle contains fine droplets, any contaminants attached on the surface of the substrate are stripped off, even if the surface has irregularities. This reliably removes the contaminants on the surface of the substrate. Moreover, even if the film on the substrate has low wettability, the fine droplets strip off the contaminants on the substrate surface, so that the contaminants can be reliably removed from the substrate surface. As a result of the foregoing, processing defects of the substrate due to the contamination after the exposure processing are prevented.

In addition, adjusting the flow rate of the gas make it easy to adjust the detergency in cleaning the substrate. Thus, when the film on the substrate is prone to damage, damage to the film on the substrate can be prevented by weakening the detergency. Tough contaminants on the substrate surface can also be removed reliably by strengthening the detergency. By adjusting the detergency in this way according to the properties of the film on the substrate and the degree of contamination, it is possible to prevent damage to the film on the substrate while cleaning the substrate reliably.

Furthermore, the substrate processing apparatus has the structure in which the second processing block is added to an existing substrate processing apparatus having the first and third processing blocks. This prevents processing defects of the substrate at low cost.

(15)

The second processing unit may apply cleaning processing to the substrate by supplying a fluid mixture containing an inert gas and a cleaning liquid onto the substrate from the fluid nozzle.

The use of the inert gas prevents a chemical influence upon the film on the substrate and the cleaning liquid while removing the contaminants on the substrate surface more reliably As a result, processing defects of the substrate due to the contamination after the exposure processing are sufficiently prevented.

(16)

The second processing unit may apply drying processing to the substrate after the cleaning processing to the substrate.

In this case, the second processing block is arranged adjacent to the interface, which allows the drying and the cleaning processing to be applied to the substrate immediately after the exposure processing. For this reason, even if a liquid is attached to the substrate in the exposure device, it is possible to prevent the liquid from dropping in the substrate processing apparatus. As a result, in the substrate processing apparatus, operational troubles such as abnormalities in the electric system are prevented. In addition, drying the substrate after the cleaning processing prevents particles and the like in the atmosphere from attaching to the substrate, which prevents contamination of the substrate. This allows processing defects of the substrate to be reduced.

In addition, the component of the photosensitive material on the substrate can be reliably prevented from being eluted in the liquid remaining on the substrate. This prevents the deformation of an exposure pattern formed on the substrate. As a result, processing defects of the substrate during the development processing in the third processing unit are prevented.

(17)

The second processing unit may include an inert gas supplier that applies drying processing to the substrate by supplying an inert gas onto the substrate. The use of the inert gas prevents a chemical influence upon the film on the substrate while reliably drying the substrate.

(18)

The fluid nozzle may function as the inert gas supplier. In this case, the inert gas is supplied onto the substrate from the fluid nozzle to apply drying processing to the substrate. This obviates the need to provide the inert gas supplier separately from the fluid nozzle. As a result, the cleaning and drying processings can be reliably applied to the substrate with a simple structure.

(19)

The second processing unit may further include a substrate holding device that holds the substrate substantially horizontally, and a rotation-driving device that rotates the substrate held on the substrate holding device about an axis vertical to the substrate.

In the second processing unit, the substrate is held on the substrate holding device substantially horizontally, and the substrate is rotated about the axis vertical to the substrate by the rotation-driving device. Then, the fluid mixture containing the inert gas and the cleaning liquid is supplied onto the substrate from the fluid nozzle, followed by the supply of the inert gas from the inert gas supplier.

In this case, since the substrate is rotated as the inert gas is supplied onto the substrate, the fluid mixture remaining on the substrate after the cleaning of the substrate is efficiently removed. This reliably prevents the deposits of particles and the like from remaining on the substrate and the substrate is reliably dried. This reliably prevents the component of the photosensitive material from being eluted in the liquid attached to the substrate during the transport of the substrate after the drying processing to the third processing unit. This reliably prevents the deformation of the exposure pattern formed on the photosensitive film. As a result, processing defects of the substrate during the development processing in the third processing unit are reliably prevented.

(20)

The second processing unit may supply the inert gas so that the fluid mixture supplied onto the substrate from the fluid nozzle is removed from the substrate as the fluid mixture moves outwardly from the center of the substrate.

This prevents the fluid mixture from remaining on the center of the substrate, thus reliably preventing the generation of dry marks (dry stains) on a surface of the substrate. In addition, this reliably prevents the component of the photosensitive material from being eluted in the liquid attached to the substrate during the transport of the substrate after the drying processing to the third processing unit. This reliably prevents the deformation of the exposure pattern formed on the photosensitive film. As a result, processing defects of the substrate during the development processing in the third processing unit are reliably prevented.

(21)

The second processing unit may further include a rinse liquid supplier that supplies a rinse liquid onto the substrate, after the supply of the fluid mixture from the fluid nozzle and before the supply of the inert gas from the inert gas supplier.

This allows the fluid mixture to be reliably cleaned away by the rinse liquid, thus reliably preventing the deposits of particles and the like from remaining on the substrate.

(22)

The fluid nozzle may function as the rinse liquid supplier. In this case, the rinse liquid is supplied from the fluid nozzle. This obviates the need to provide the rinse liquid supplier separately from the fluid nozzle. As a result, the cleaning and drying processings can be reliably applied to the substrate with a simple structure.

(23)

The second processing unit may supply the inert gas so that the rinse liquid supplied onto the substrate from the rinse liquid supplier is removed from the substrate as the rinse liquid moves outwardly from the center of the substrate.

This prevents the rinse liquid from remaining on the center of the substrate, thus reliably preventing the generation of dry marks on the surface of the substrate. In addition, this reliably prevents the component of the photosensitive material from being eluted in the liquid attached to the substrate during the transport of the substrate after the drying processing to the third processing unit. This reliably prevents the deformation of the exposure pattern formed on the photosensitive film. As a result, processing defects of the substrate during the development processing in the third processing unit are reliably prevented.

(24)

The fluid nozzle may have a liquid flow passage through which a liquid flows, a gas flow passage through which a gas flows, a liquid discharge port having an opening that communicates with the liquid flow passage, and a gas discharge port that is provided near the liquid discharge port and has an opening that communicates with the gas flow passage.

In this case, the liquid flows through the liquid flow passage, and is discharged from the liquid discharge port, while the gas flows through the gas flow passage, and is discharged from the gas discharge port. The liquid and gas are mixed outside the fluid nozzle. A mist-like fluid mixture is thus generated.

In this way, the fluid mixture is generated by mixing the liquid and the gas outside the fluid nozzle. This obviates the need to provide space for mixing the liquid and the gas inside the fluid nozzle. As a result, the size of the fluid nozzle can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus according to a first embodiment of the invention;

FIG. 2 is a side view of the substrate processing apparatus in FIG. 1 that is seen from the +X direction;

FIG. 3 is a side view of the substrate processing apparatus in FIG. 1 that is seen from the −X direction;

FIG. 4 is a diagram for use in illustrating the configuration of the drying processing unit;

FIGS. 5(a), 5(b), and 5(c) are diagrams for use in illustrating the operation of the drying processing unit;

FIG. 6 is a schematic diagram of a nozzle in which a nozzle for cleaning processing and a nozzle for drying processing are formed integrally;

FIG. 7 is a schematic diagram showing another example of the nozzle for drying processing;

FIGS. 8(a), 8(b), and 8(c) are diagrams for use in illustrating a method of applying drying processing to a substrate using the nozzle in FIG. 7;

FIG. 9 is a schematic diagram showing another example of the nozzle for drying processing;

FIG. 10 is a schematic diagram showing another example of the drying processing unit;

FIG. 11 is a diagram for use in illustrating a method of applying drying processing to the substrate using the drying processing unit in FIG. 10;

FIG. 12 is a diagram for use in illustrating the configuration and operation of the interface transport mechanism;

FIG. 13 is a longitudinal cross section showing an example of the internal structure of a two-fluid nozzle for use in cleaning and drying processings; and

FIGS. 14(a), 14(b), and 14(c) are diagrams for use in illustrating a method of applying drying processing to the substrate using the two-fluid nozzle in FIG. 13.

### DETAILED DESCRIPTION OF THE PREFERRED EMBODIMENTS

A substrate processing apparatus according to embodiments of the invention will be described below with reference to the drawings. A substrate as used in the specification includes a semiconductor substrate, a substrate for a liquid crystal display, a substrate for a plasma display, a glass substrate for a photomask, a substrate for an optical disk, a substrate for a magnetic disk, a substrate for a magneto-optical disk, and a substrate for a photomask.

### (1) First Embodiment

### (1-1) Configuration of Substrate Processing Apparatus

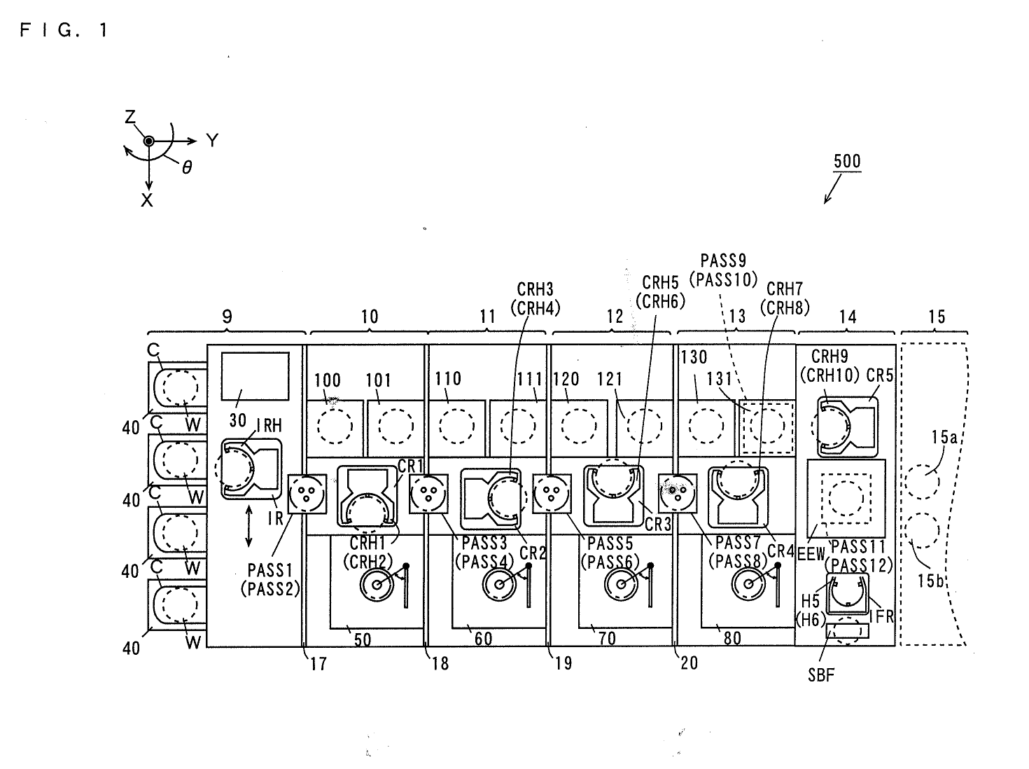

FIG. 1 is a plan view of a substrate processing apparatus according to a first embodiment of the invention.

FIG. 1 and each of the subsequent drawings is accompanied by the arrows that indicate X, Y, and Z directions perpendicular to one another, for clarification of positions. The X and Y directions are perpendicular to each other in a horizontal plane, and the Z direction corresponds to the vertical direction. In each of the directions, the direction toward an arrow is defined as +direction, and the opposite direction is defined as −direction. The rotation direction about the Z direction is defined as θ direction.

As shown in FIG. 1, the substrate processing apparatus 500 includes an indexer block 9, an anti-reflection film processing block 10, a resist film processing block 11, a development processing block 12, a drying processing block 13, and an interface block 14. An exposure device 15 is arranged adjacent to the interface block 14. The exposure device 15 applies exposure processing to substrates W by a liquid immersion method.

Each of the indexer block 9, anti-reflection film processing block 10, resist film processing block 11, development processing block 12, drying processing block 13, and interface block 14 will hereinafter be referred to as a processing block.

The indexer block 9 includes a main controller (controller) 30 for controlling the operation of each processing block, a plurality of carrier platforms 40, and an indexer robot IR. The indexer robot IR has a hand IRH for receiving and transferring the substrates W.

The anti-reflection film processing block 10 includes thermal processing groups 100, 101 for anti-reflection film, a coating processing group 50 for anti-reflection film, and a first central robot CR1. The coating processing group 50 is arranged opposite to the thermal processing groups 100, 101 with the first central robot CR1 therebetween. The first central robot CR1 has hands CRH1, CRH2 provided one above the other for receiving and transferring the substrates W.

A partition wall 17 is arranged between the indexer block 9 and the anti-reflection film processing block 10 for shielding an atmosphere. The partition wall 17 has substrate platforms PASS1, PASS2 provided closely one above the other for receiving and transferring the substrates W between the indexer block 9 and the anti-reflection film processing block 10. The upper substrate platform PASS1 is used in transferring the substrates W from the indexer block 9 to the anti-reflection film processing block 10, and the lower substrate platform PASS2 is used in transferring the substrates W from the anti-reflection film processing block 10 to the indexer block 9.

Each of the substrate platforms PASS1, PASS2 has an optical sensor (not shown) for detecting the presence or absence of a substrate W. This enables a determination to be made whether or not a substrate W is on the substrate platform PASS1, PASS2. In addition, each of the substrate platforms PASS1, PASS2 has a plurality of support pins secured thereto. Note that each of substrate platforms PASS3 to PASS12 mentioned below similarly has such optical sensor and support pins.

The resist film processing block 11 includes thermal processing groups 110, 111 for resist film, a coating processing group 60 for resist film, and a second central robot CR2. The coating processing group 60 is arranged opposite to the thermal processing groups 110, 111 with the second central robot CR2 therebetween. The second central robot CR2 has hands CRH3, CRH4 provided one above the other for receiving and transferring the substrates W.

A partition wall 18 is arranged between the anti-reflection film processing block 10 and the resist film processing block 11 for shielding an atmosphere. The partition wall 18 has substrate platforms PASS3, PASS4 provided closely one above the other for receiving and transferring the substrates W between the anti-reflection film processing block 10 and the resist film processing block 11. The upper substrate platform PASS3 is used in transferring the substrates W from the anti-reflection film processing block 10 to the resist film processing block 11. The lower substrate platform PASS4 is used in transferring the substrates W from the resist film processing block 11 to the anti-reflection film processing block 10.

The development processing block 12 includes thermal processing groups 120, 121 for development, a development processing group 70, and a third central robot CR3. The development processing group 70 is arranged opposite to the thermal processing groups 120, 121 with the third central robot CR3 therebetween. The third central robot CR3 has hands CRH5, CRH6 provided one above the other for receiving and transferring the substrates W.

A partition wall 19 is arranged between the resist film processing block 11 and the development processing block 12 for shielding an atmosphere. The partition wall 19 has substrate platforms PASS5, PASS6 provided closely one above the other for receiving and transferring the substrates W between the resist film processing block 11 and the development processing block 12. The upper substrate platform PASS5 is used in transferring the substrates W from the resist film processing block 11 to the development processing block 12, and the lower substrate platform PASS6 is used in transferring the substrates W from the development processing block 12 to the resist film processing block 11.

The drying processing block 13 includes thermal processing groups 130, 131 for post-exposure bake (PEB), a drying processing group 80, and a fourth central robot CR4. The thermal processing group 131, adjacent to the interface block 14, has substrate platforms PASS9, PASS10 as described below. The drying processing group 80 is arranged opposite to the thermal processing groups 130, 131 with the fourth central robot CR4 therebetween. The fourth central robot CR4 has hands CRH7, CRH8 provided one above the other for receiving and transferring the substrates W.

A partition wall 20 is arranged between the development processing block 12 and the drying processing block 13 for shielding an atmosphere. The partition wall 20 has substrate platforms PASS7, PASS8 provided closely one above the other for receiving and transferring the substrates W between the development processing block 12 and the drying processing block 13. The upper substrate platform PASS7 is used in transferring the substrates W from the development processing block 12 to the drying processing block 13, and the lower substrate platform PASS8 is used in transferring the substrates W from the drying processing block 13 to the development processing block 12.

The interface block 14 includes a fifth central robot CR5, a send buffer unit SBF, an interface transport mechanism IFR, and edge exposure units EEW. A return buffer unit RBF, and substrate platforms PASS11, PASS12 are provided under the edge exposure units EEW as described below. The fifth central robot CR5 has hands CRH9, CRH10 provided one above the other for receiving and transferring the substrates W, the interface transport mechanism IFR has hands H5, H6 provided one above the other for receiving and transferring the substrates W.

In the substrate processing apparatus 500 of the embodiment, the indexer block 9, the anti-reflection film processing block 10, resist film processing block 11, development processing block 12, drying processing block 13, and interface block 14 are sequentially arranged in parallel along the Y direction.

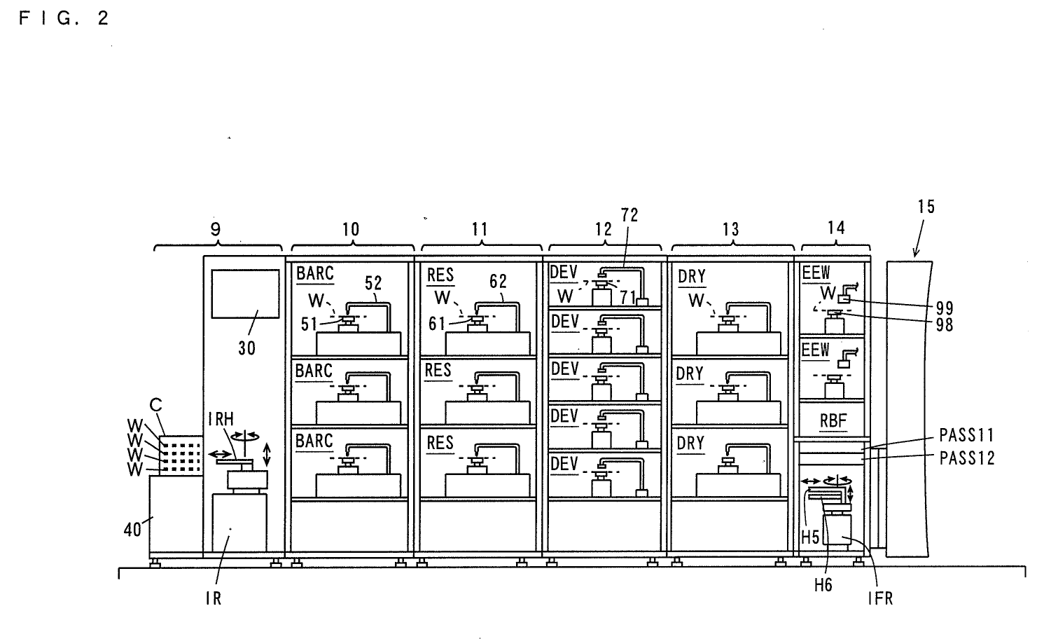

FIG. 2 is a side view of the substrate processing apparatus 500 in FIG. 1 that is seen from the +X direction.

The coating processing group 50 in the anti-reflection film processing block 10 (see FIG. 1) includes a vertical stack of three coating units BARC. Each of the coating units BARC comprises a spin chuck 51 for rotating a substrate W while holding the substrate W in a horizontal attitude by suction, and a supply nozzle 52 for supplying coating liquid for an anti-reflection film to the substrate W held on the spin chuck 51.

The coating processing group 60 in the resist film processing block 11 (see FIG. 1) includes a vertical stack of three coating units RES. Each of the coating units RES comprises a spin chuck 61 for rotating a substrate W while holding the substrate W in a horizontal attitude by suction, and a supply nozzle 62 for supplying coating liquid for a resist film to the substrate W held on the spin chuck 61.

The development processing group 70 in the development processing block 12 (see FIG. 1) includes a vertical stack of five development processing units DEV. Each of the development processing units DEV comprises a spin chuck 71 for rotating a substrate W while holding the substrate W in a horizontal attitude by suction, and a supply nozzle 72 for supplying development liquid to the substrate W held on the spin chuck 71.

The drying processing group 80 in the drying processing block 13 (see FIG. 1) includes a vertical stack of three drying processing units DRY. The drying processing units DRY apply cleaning and drying processings to the substrates W. The drying processing units DRY will be described in detail below.

The interface block 14 includes a vertical stack of two edge exposure units EEW, a return buffer unit RBF, and substrate platforms PASS11, PASS12, and also includes the fifth central robot CR5 (see FIG. 1) and interface transport mechanism IFR. Each of the edge exposure units EEW comprises a spin chuck 98 for rotating a substrate W while holding the substrate W in a horizontal attitude by suction, and a light irradiator 99 for subjecting a peripheral edge of the substrate W held on the spin chuck 98 to exposure.

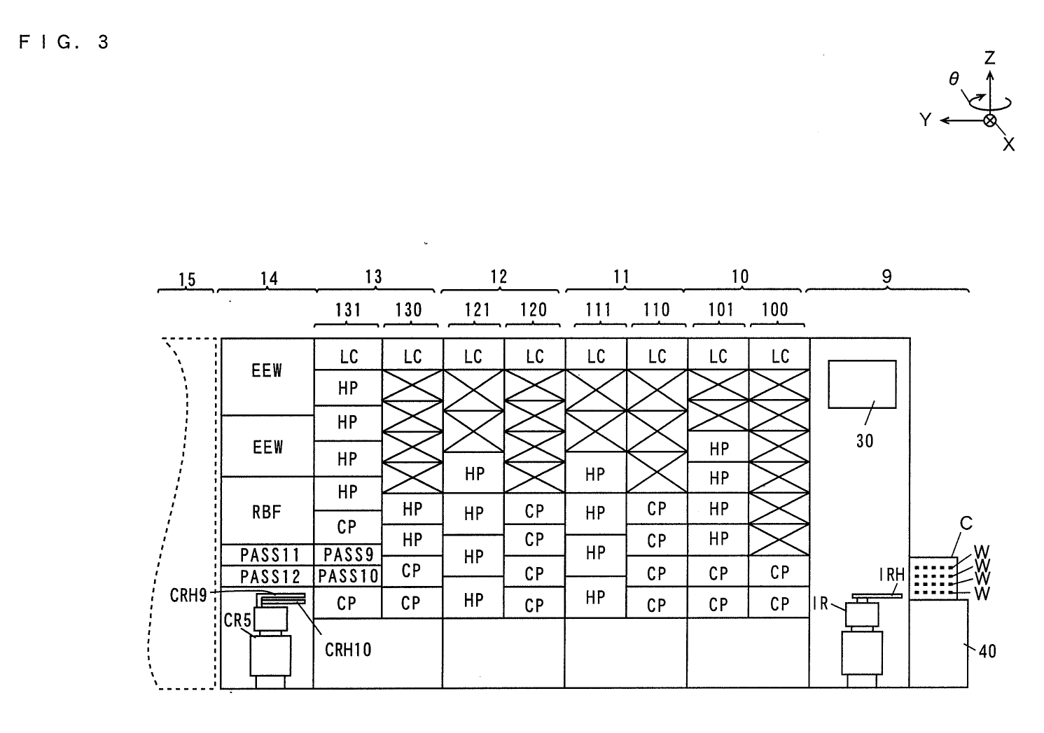

FIG. 3 is a side view of the substrate processing apparatus 500 in FIG. 1 that is seen from the −X direction.

In the anti-reflection film processing block 10, the thermal processing group 100 includes a vertical stack of two cooling units (cooling plates) CP, and the thermal processing group 101 includes a vertical stack of four heating units (hot plates) HP and two cooling units CP. The thermal processing group 100 also includes a local controller LC on top thereof for controlling the temperatures of the cooling units CP, and the thermal processing group 101 also includes a local controller LC on top thereof for controlling the temperatures of the heating units HP and the cooling units CP.

In the resist film processing block 11, the thermal processing group 110 includes a vertical stack of four cooling units CP, and the thermal processing group 111 includes a vertical stack of four heating units HP. The thermal processing group 110 also includes a local controller LC on top thereof for controlling the temperatures of the cooling units CP, and the thermal processing group 111 also includes a local controller LC on top thereof for controlling the temperatures of the heating units HP.

In the development processing block 12, the thermal processing group 120 includes a vertical stack of four cooling units CP, and the thermal processing group 121 includes a vertical stack of four heating units HP. The thermal processing group 120 also includes a local controller LC on top thereof for controlling the temperatures of the cooling units CP, and the thermal processing group 121 also includes a local controller LC for controlling the temperatures of the heating units HP.

In the drying processing block 13, the thermal processing group 130 includes a vertical stack of two heating units HP and the two cooling units CP, and the thermal processing group 131 includes a vertical stack of four heating units HP, a cooling units CP, substrate platforms PASS9, PASS10 and a cooling units CP. The thermal processing group 130 also includes a local controller LC on top thereof for controlling the temperatures of the heating units HP and the cooling units CP, and the thermal processing group 131 also includes a local controller LC for controlling the temperatures of the heating units HP and the cooling units CP.

The numbers of the coating units BARC, RES, the development processing units DEV, the drying processing units DRY, the heating unit HP and the cooling unit CP may suitably be changed according to the processing speed of each processing block.

### (1-2) Operation of Substrate Processing Apparatus

Next, the operation of the substrate processing apparatus 500 in this embodiment will be described.

Carriers C for storing the substrates W in multiple stages are mounted on the carrier platforms 40, respectively, in the indexer block 9. The indexer robot IR takes out a substrate W yet to be processed which is stored in a carrier C using the hand IRH. Then, the indexer robot IR moves in the ±X direction while rotating in the ±θ direction to transfer the unprocessed substrate W onto the substrate platform PASS1.

Although FOUPs (Front Opening Unified Pods) are adopted as the carriers C in this embodiment, SMIF (Standard Mechanical Inter Face) pods or OCs (Open Cassettes) that expose stored substrates W to outside air may also be used, for example. In addition, although linear-type transport robots that move their hands forward or backward by sliding them linearly to a substrate W are used as the indexer robot IR, the first central robot CR1 to the fifth central robot CR5, and the interface transport mechanism IFR, multi joint type transport robots that linearly move their hands forward and backward by moving their joints may also be used.

The unprocessed substrate W that has been transferred onto the substrate platform PASS1 is received by the first central robot CR1 in the anti-reflection film processing block 10. The first central robot CR1 carries the substrate W to the thermal processing group 100 or 101.

After this, the first central robot CR1 takes out the thermally treated substrate W from the thermal processing group 100 or 101, and then carries the substrate W to the coating processing group 50. The coating processing group 50 forms a coating of an anti-reflection film over a lower portion of a photoresist film using a coating unit BARC, in order to reduce potential standing waves and halation generated during exposure.

The first central robot CR1 subsequently takes out the substrate W after the coating processing from the coating processing group 50, and carries the substrate W to the thermal processing group 100 or 101. Then, the first central robot CR1 takes out the thermally treated substrate W from the thermal processing group 100 or 101, and transfers the substrate W to the substrate platform PASS3.

The substrate Won the substrate platform PASS3 is received by the second central robot CR2 in the resist film processing block 11. The second central robot CR2 carries the substrate W to the thermal processing group 110 or 111.

The second central robot CR2 then takes out the thermally treated substrate W from the thermal processing group 110 or 111, and transfers the substrate W to the coating processing group 60. The coating processing group 60 forms a coating of a resist film over the substrate W coated with the anti-reflection film by a coating unit RES.

After this, the second central robot CR2 takes out the substrate W after the coating processing from the coating processing group 60, and carries the substrate W to the thermal processing group 110 or 111. Then, the second central robot CR2 takes out the thermally treated substrate W from the thermal processing group 110 or 111, and transfers the substrate W onto the substrate platform PASS5.

The substrate W on the substrate platform PASS5 is received by the third central robot CR3 in the development processing block 12. The third central robot CR3 transfers the substrate W onto the substrate platform PASS7.

The substrate W on the substrate platform PASS7 is received by the fourth central robot CR4 in the drying processing block 13. The fourth central robot CR4 transfers the substrate W onto the substrate platform PASS9.

The substrate Won the substrate platform PASS9 is received by the fifth central robot CR5 in the interface block 14. The fifth central robot CR5 transfers the substrate W to an edge exposure unit EEW. The edge exposure unit EEW applies exposure processing to the peripheral portion of the substrate W.

Then, the fifth central robot CR5 takes out the substrate W after the edge exposure processing from the edge exposure unit EEW, and transfers the substrate W onto the substrate platform PASS11. The substrate W on the substrate platform PASS11 is carried into the exposure device 15 by the interface transport mechanism IFR. After exposure processing has been applied to the substrate W by the exposure device 15, the interface transport mechanism IFR transports the substrate W to a drying processing group 80. The drying processing group 80 applies cleaning and drying processings to the substrates W as described above. After drying processings have been applied to the substrate W by the drying processing group 80, the interface transport mechanism IFR transfers the substrate W to the substrate platform PASS12. The interface transport mechanism IFR will be described below.

The substrate Won the substrate platform PASS12 is received by the fifth central robot CR5 in the interface block 14. The fifth central robot CR5 carries the substrate W into the thermal processing group in the drying processing block 13. The thermal processing group 131 applies a post-exposure baketo the substrate W. It is noted that the post-exposure bake may be performed by the thermal processing group 130.

After this, the fifth central robot CR5 takes out the substrate W from the thermal processing group 131, and transfers the substrate W onto the substrate platform PASS10. The substrate W on the substrate platform PASS10 is received by the fourth central robot CR4 in the drying processing block 13. The fourth central robot CR4 transfers the substrate W onto the substrate platform PASS8.

The substrate W on the substrate platform PASS8 is received by the third central robot CR3 in the development processing block 12. The third central robot CR3 carries the substrate W into the development processing group 70. The development processing group 70 applies development processing to the exposed substrate W. After this, the third central robot CR3 takes out the substrate W after the development processing from the development processing group 70, and transfers the substrate W to the thermal processing group 120 or 121.

Then, the third central robot CR3 takes out the thermally treated substrate W from the thermal processing group 120 or 121, and transfers the substrate W onto the substrate platform PASS6. The substrate W on the substrate platform PASS6 is transferred onto the substrate platform PASS4 by the second central robot CR2 in the resist film processing block 11. The substrate W on the substrate platform PASS4 is transferred onto the substrate platform PASS2 by the first central robot CR1 in the anti-reflection film processing block 10.

The substrate W on the substrate platform PASS2 is stored in a carrier C by the indexer robot IR in the indexer block 9. Each of the processings to the substrate W in the substrate processing apparatus 500 is thus completed.

### (1-3) Drying Processing Unit

The aforementioned drying processing units DRY are now described in detail with reference to the drawings.

### (1-3a) Configuration of Drying Processing Unit

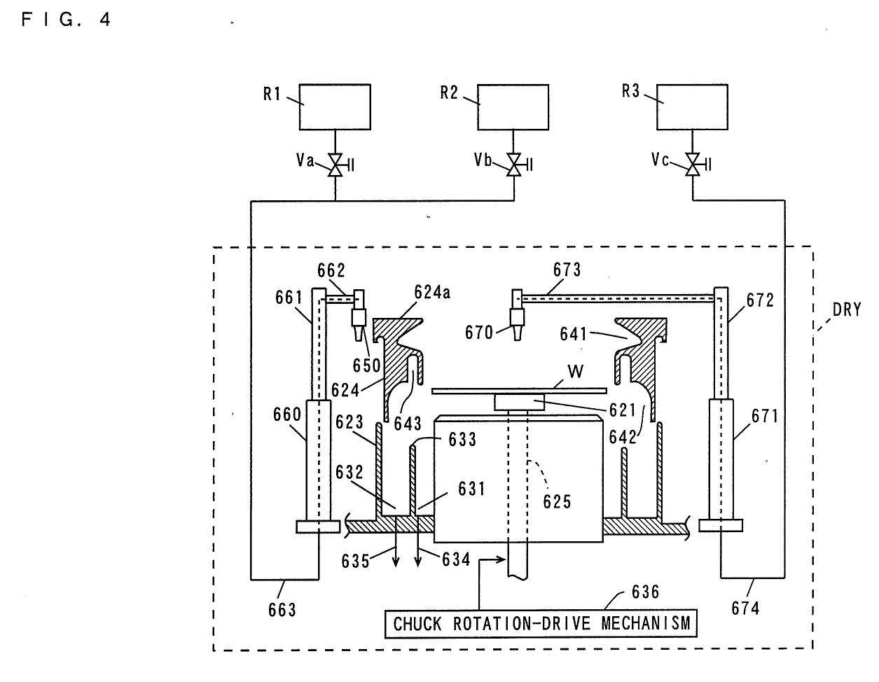

The configuration of each of the drying processing units DRY is first described. FIG. 4 is a diagram for use in illustrating the configuration of the drying processing unit DRY.

As shown in FIG. 4, the drying processing unit DRY comprises a spin chuck 621 for rotating a substrate W about the vertical rotation axis passing through the center of the substrate W while horizontally holding the substrate W.

The spin chuck 621 is secured to an upper end of a rotation shaft 625, which is rotated via a chuck rotation-drive mechanism 636. An air suction passage (not shown) is formed in the spin chuck 621. With the substrate W being mounted on the spin chuck 621, air inside the air suction passage is discharged, so that a lower surface of the substrate W is sucked onto the spin chuck 621 by vacuum, and the substrate W is held in a horizontal attitude.

A first rotation motor 660 is arranged outside the spin chuck 621. The first rotation motor 660 is connected to a first rotation shaft 661. The first rotation shaft 661 is coupled to a first arm 662, which extends in the horizontal direction, and whose end is provided with a nozzle 650 for cleaning processing.

The first rotation shaft 661 is rotated by the first rotation motor 660, so that the first arm 662 swings. This causes the nozzle 650 to move above the substrate W held on the spin chuck 621.

A supply pipe 663 for cleaning processing is arranged so as to pass through the inside of the first rotation motor 660, first rotation shaft 661, and first arm 662. The supply pipe 663 is connected to a cleaning liquid supply source R1 and a rinse liquid supply source R2 through a valve Va and a valve Vb, respectively. Controlling the opening and closing of the valves Va, Vb allows the selection of the processing liquid supplied to the supply pipe 663 and adjustments of the amount thereof. In the configuration of FIG. 4, when the valve Va is opened, cleaning liquid is supplied to the supply pipe 663, and when the valve Vb is opened, rinse liquid is supplied to the supply pipe 663.

The cleaning liquid or the rinse liquid is supplied to the nozzle 650 through the supply pipe 663 from the cleaning liquid supply source R1 or the rinse liquid supply source R2. The cleaning liquid or the rinse liquid is thus supplied to a surface of the substrate W. Examples of the cleaning liquid may include pure water, a pure water solution containing a complex (ionized), or a fluorine-based chemical solution. Examples of the rinse liquid may include pure water, carbonated water, hydrogen water, electrolytic ionic water, and HFE (hydrofluoroether).

A second rotation motor 671 is arranged outside the spin chuck 621. The second rotation motor 671 is connected to a second rotation shaft 672. The second rotation shaft 672 is coupled to a second arm 673, which extends in the horizontal direction, and whose end is provided with a nozzle 670 for drying processing.

The second rotation shaft 672 is rotated by the second rotation motor 671, so that the second arm 673 swings. This causes the nozzle 670 to move above the substrate W held on the spin chuck 621.

A supply pipe 674 for drying processing is arranged so as to pass through the inside of the second rotation motor 671, second rotation shaft 672, and second arm 673. The supply pipe 674 is connected to an inert gas supply source R3 through a valve Vc. Controlling the opening and closing of the valve Vc allows adjustments to be made to the amount of the inert gas supplied to the supply pipe 674.

The inert gas is supplied to the nozzle 670 through the supply pipe 674 from the inert gas supply source R3. The inert gas is thus supplied to the surface of the substrate W. Nitrogen gas (N₂), for example, may be used as the inert gas.

When supplying the cleaning liquid or the rinse liquid onto the surface of the substrate W, the nozzle 650 is positioned above the substrate. When supplying the inert gas onto the surface of the substrate W, the nozzle 650 is retracted to a predetermined position.

When supplying the cleaning liquid or the rinse liquid onto the surface of the substrate W, the nozzle 670 is retracted to a predetermined position. When supplying the inert gas onto the surface of the substrate W, the nozzle 670 is positioned above the substrate W.

The substrate W held on the spin chuck 621 is housed in a processing cup 623. A cylindrical partition wall 633 is provided inside the processing cup 623. A discharge space 631 is formed so as to surround the spin chuck 621 for discharging the processing liquid (i.e., cleaning liquid or rinse liquid) used in processing the substrate W. Also, a liquid recovery space 632 is formed between the processing cup 623 and the partition wall 633, so as to surround the discharge space 631, for recovering the processing liquid used in processing the substrate W.

The discharge space 631 is connected with a discharge pipe 634 for directing the processing liquid to a liquid discharge processing device (not shown), while the liquid recovery space 632 is connected with a recovery pipe 635 for directing the processing liquid to a recovery processing device (not shown).

A guard 624 is provided above the processing cup 623 for preventing the processing liquid on the substrate W from splashing outward. The guard 624 is configured to be rotation-symmetric with respect to the rotation shaft 625. A liquid discharge guide groove 641 with a V-shaped cross section is formed in a circular shape inwardly of an upper end portion of the guard 624.

Also, a liquid recovery guide 642 having an inclined surface that inclines down outwardly is formed inwardly of a lower portion of the guard 624. A partition wall housing groove 643 for receiving the partition wall 633 in the processing cup 623 is formed in the vicinity of the upper end of the liquid recovery guide 642.

This guard 624 is provided with a guard lifting mechanism (not shown) composed of a ball screw mechanism or the like. The guard lifting mechanism lifts and lowers the guard 624 between a recovery position in which the liquid recovery guide 642 is positioned opposite to outer edges of the substrate W held on the spin chuck 621 and a discharge position in which the liquid discharge guide groove 641 is positioned opposite to the outer edges of the substrate W held on the spin chuck 621. When the guard 624 is in the recovery position (i.e., the position of the guard shown in FIG. 4), the processing liquid splashed out from the substrate W is directed by the liquid recovery guide 642 to the liquid recovery space 632, and then recovered through the recovery pipe 635. On the other hand, when the guard 624 is in the discharge position, the processing liquid splashed out from the substrate W is directed by the liquid discharge guide groove 641 to the discharge space 631, and then discharged through the discharge pipe 634. With the above-described configuration, discharge and recovery of the processing liquid is performed.

### (1-3b) Operation of Drying Processing Unit

The processing operation of the drying processing unit DRY having the above-described configuration is next described. Note that the operation of each component in the drying processing unit DRY described below is controlled by the main controller 30 in FIG. 1.

When the substrate W is initially carried into the drying processing unit DRY, the guard 624 is lowered, and the interface transport mechanism IFR in FIG. 1 places the substrate W onto the spin chuck 621. The substrate W on the spin chuck 621 is held by suction.

Next, the guard 624 moves to the aforementioned discharge position, and the nozzle 650 moves above the center of the substrate W. Then, the rotation shaft 625 rotates, causing the substrate W held on the spin chuck 621 to rotate. After this, the cleaning liquid is discharged onto the top surface of the substrate W from the nozzle 650. This provides cleaning of the substrate W. Note that the supply of the cleaning liquid onto the substrate W may be executed by a soft spray method using a two-fluid nozzle. An example of the drying processing unit DRY using a two-fluid nozzle will be described in the second embodiment.

After the elapse of a predetermined time, the supply of the cleaning liquid is stopped, and the rinse liquid is discharged from the nozzle 650. The cleaning liquid on the substrate W is thus cleaned away.

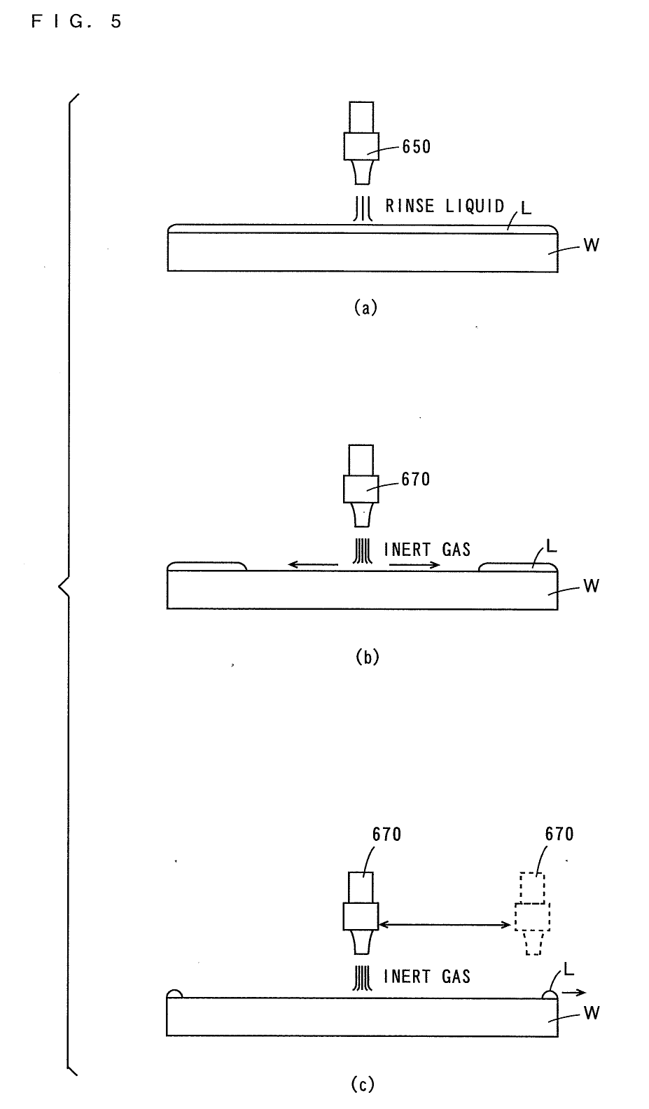

After the elapse of another predetermined time, the rotation speed of the rotation shaft 625 decreases. This reduces the amount of the rinse liquid that is shaken off by the rotation of the substrate W, resulting in the formation of a liquid layer L of the rinse liquid over the entire surface of the substrate W, as shown in FIG. 5(a). Alternatively, the rotation of the rotation shaft 625 may be stopped to form the liquid layer L over the entire surface of the substrate W.

The embodiment employs the configuration in which the nozzle 650 is used for supplying both the cleaning liquid and the rinse liquid, so as to supply both the cleaning liquid and the rinse liquid from the nozzle 650. However, a configuration may also be employed in which nozzles are separately provided for supplying the cleaning liquid and the rinse liquid.

In order to prevent the rinse liquid from flowing to the back surface of the substrate W during the supply of the rinse liquid, pure water may be supplied to the back surface of the substrate W from a back rinsing nozzle (not shown).

Note that when using pure water as the cleaning liquid for cleaning the substrate W, it is not necessary to supply the rinse liquid.

The supply of the rinse liquid is subsequently stopped, and the nozzle 650 retracts to the predetermined position while the nozzle 670 moves above the center of the substrate W. The inert gas is subsequently discharged from the nozzle 670. This causes the rinse liquid around the center of the substrate W to move toward a peripheral portion of the substrate W, leaving the liquid layer L only on the peripheral portion, as shown in FIG. 5(b).

Next, as the number of revolutions of the rotation shaft 625 (see FIG. 4) increases, the nozzle 670 gradually moves from above the center of the substrate W to above the peripheral portion thereof, as shown in FIG. 5(c). This causes a great centrifugal force acting on the liquid layer L on the substrate W while allowing the inert gas to be sprayed toward the entire surface of the substrate W, thereby ensuring the removal of the liquid layer L on the substrate W. As a result, the substrate W can be reliably dried.

Then, the supply of the inert gas is stopped, and the nozzle 670 retracts to the predetermined position while the rotation of the rotation shaft 625 is stopped. After this, the guard 624 is lowered, and the interface transport mechanism IFR in FIG. 1 carries the substrate W out of the drying processing unit DRY. The processing operation of the drying processing unit DRY is thus completed.

It is preferred that the position of the guard 624 during cleaning and drying processings is suitably changed according to the necessity of the recovery or discharge of the processing liquid.

### (1-3c) Another Example of Drying Processing Unit

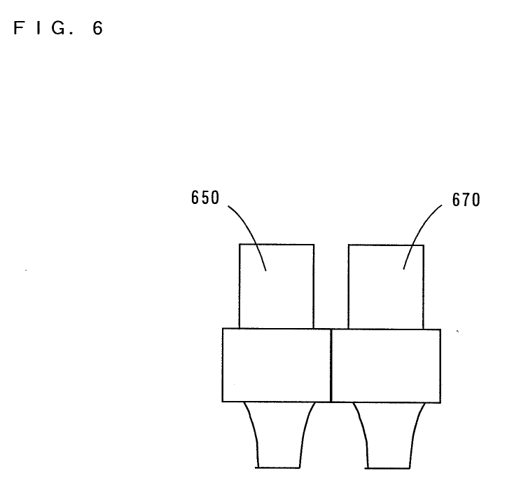

Although the drying processing unit DRY shown in FIG. 4 includes the nozzle 650 for cleaning processing and the nozzle 670 for drying processing separately, the nozzle 650 and the nozzle 670 may also be formed integrally, as shown in FIG. 6. This obviates the need to move each of the nozzle 650 and the nozzle 670 separately during the cleaning or drying processing to the substrate W, thereby simplifying the driving mechanism.

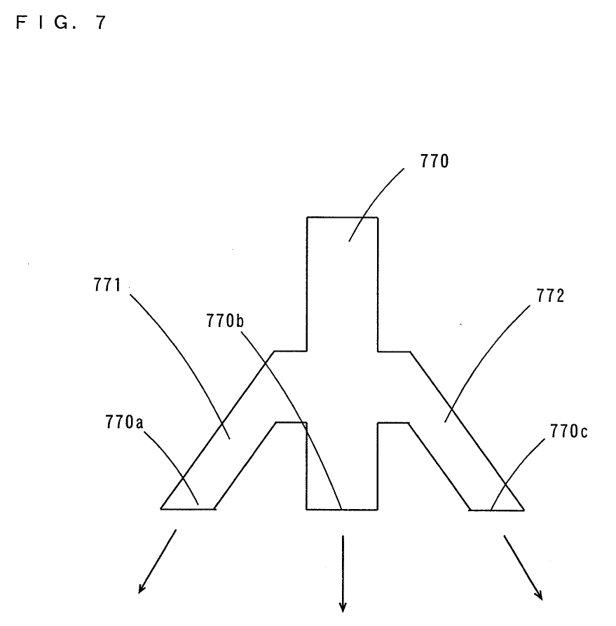

A nozzle 770 for drying processing as shown in FIG. 7 may also be used instead of the nozzle 670 for drying processing.

The nozzle 770 in FIG. 7 extends vertically downward, and also has branch pipes 771, 772 that extend obliquely downward from sides thereof. A gas discharge port 770a is formed at the lower end of the branch pipe 771, a gas discharge port 770b is formed at the lower end of the nozzle 770, and a gas discharge port 770c is formed at the lower end of the branch pipe 772, each for discharging an inert gas. The discharge port 770b discharges an inert gas vertically downward, and the discharge ports 770a, 770c each discharge an inert gas obliquely downward, as indicated by the arrows in FIG. 7. That is to say, the nozzle 770 discharges the inert gas so as to increase the spraying area downwardly.

Now, a drying processing unit DRY using the nozzle 770 for drying processing applies drying processing to the substrate W as will now be described.

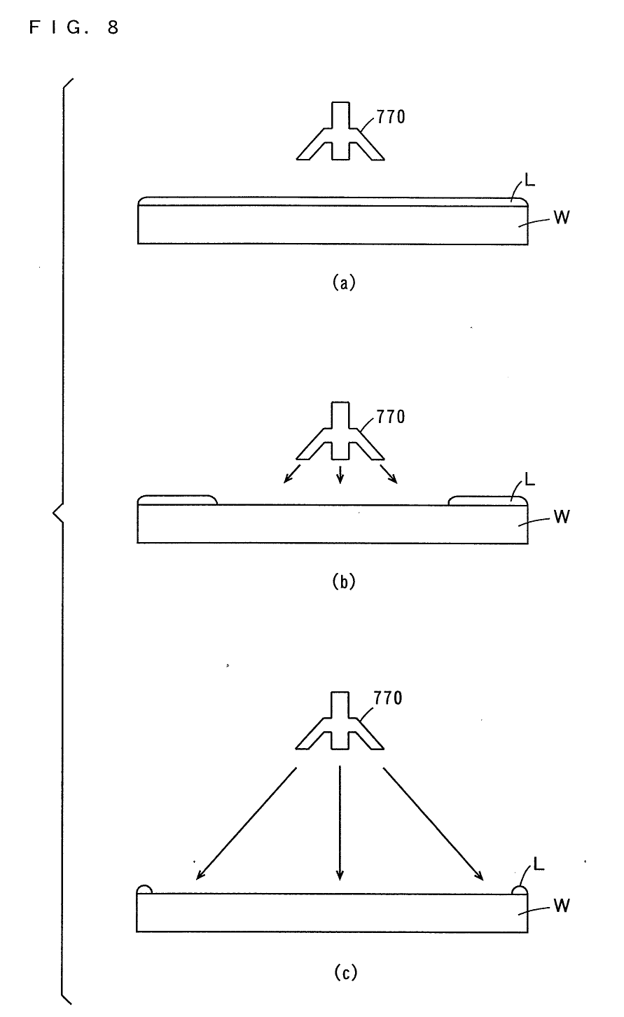

FIGS. 8(a), 8(b), 8(c) are diagrams for use in illustrating a method of applying drying processing to the substrate W using the nozzle 770.

Initially, a liquid layer L is formed on the surface of the substrate W by the method as described in FIG. 6, and then the nozzle 770 moves above the center of the substrate W, as shown in FIG. 8(a). After this, an inert gas is discharged from the nozzle 770. This causes the rinse liquid on the center of the substrate W to move to the peripheral portion of the substrate W, leaving the liquid layer L only on the peripheral portion of the substrate W, as shown in FIG. 8(b). At the time, the nozzle 770 is brought close to the surface of the substrate W so as to reliably move the rinse liquid present on the center of the substrate W.

Next, as the number of revolutions of the rotation shaft 625 (see FIG. 4) increases, the nozzle 770 moves upward as shown in FIG. 8(c). This causes a great centrifugal force acting on the liquid layer L on the substrate W while increasing the area to which the inert gas is sprayed on the substrate W. As a result, the liquid layer L on the substrate W is reliably removed. Note that the nozzle 770 can be moved up and down by lifting and lowering the second rotation shaft 672 via a rotation shaft lifting mechanism (not shown) provided to the second rotation shaft 672 in FIG. 4.

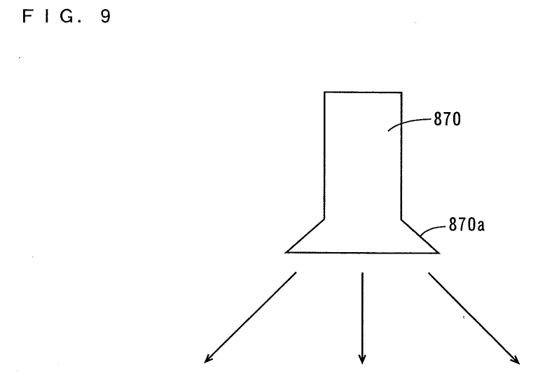

Alternatively, a nozzle 870 for drying processing as shown in FIG. 9 may be used instead of the nozzle 770. The nozzle 870 in FIG. 9 has a discharge port 870a whose diameter gradually increases downward. This discharge port 870a discharges an inert gas vertically downward and obliquely downward as indicated by the arrows in FIG. 9. That is, similarly to the nozzle 770 in FIG. 7, the nozzle 870 discharges the inert gas so as to increase the spraying area downwardly. Consequently, drying processing similar to that using the nozzle 770 can be applied to the substrate W using the nozzle 870.

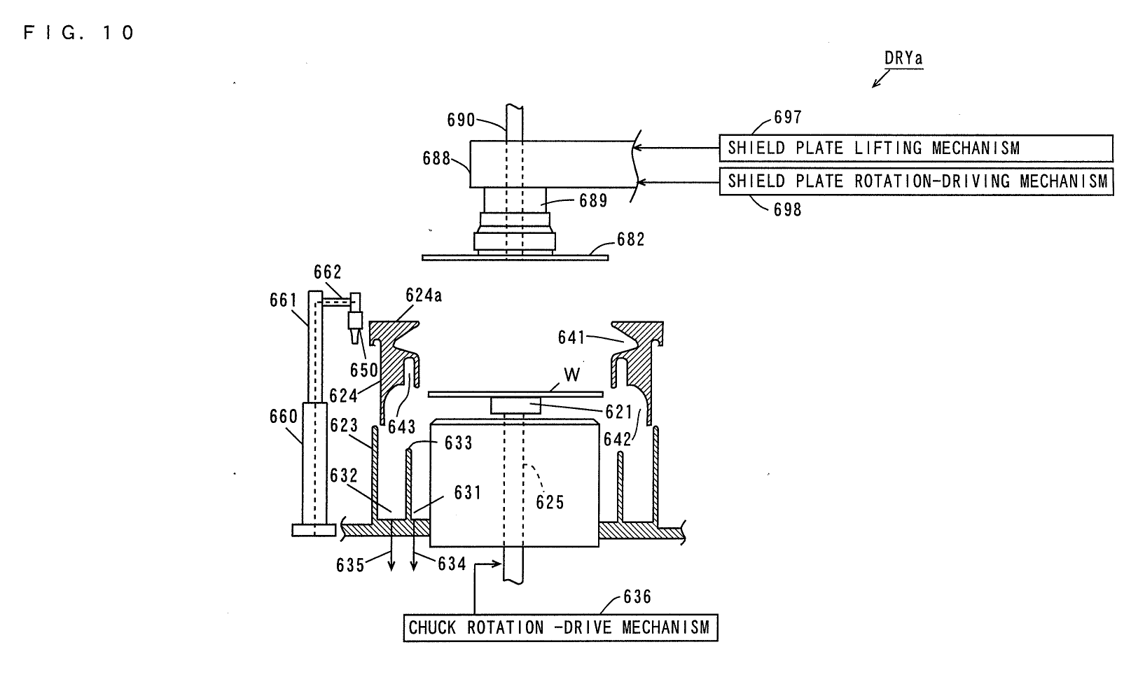

A drying processing unit DRYa as shown in FIG. 10 may also be used instead of the drying processing unit DRY shown in FIG. 4.

The drying processing unit DRYa in FIG. 10 is different from the drying processing unit DRY in FIG. 4 as described below.

The drying processing unit DRYa in FIG. 10 includes above the spin chuck 621a disk-shaped shield plate 682 having an opening through the center thereof. A support shaft 689 extends vertically downward from around an end of an arm 688, and the shield plate 682 is mounted at a lower end of the support shaft 689 so as to oppose the top surface of the substrate W held on the spin chuck 621.

A gas supply passage 690 that communicates with the opening of the shield plate 682 is inserted into the inside of the support shaft 689. A nitrogen gas (N₂), for example, is supplied into the gas supply passage 690.

The arm 688 is connected with a shield plate lifting mechanism 697 and a shield plate rotation-driving mechanism 698. The shield plate lifting mechanism 697 lifts and lowers the shield plate 682 between a position close to the top surface of the substrate W held on the spin chuck 621 and a position upwardly away from the spin chuck 621.

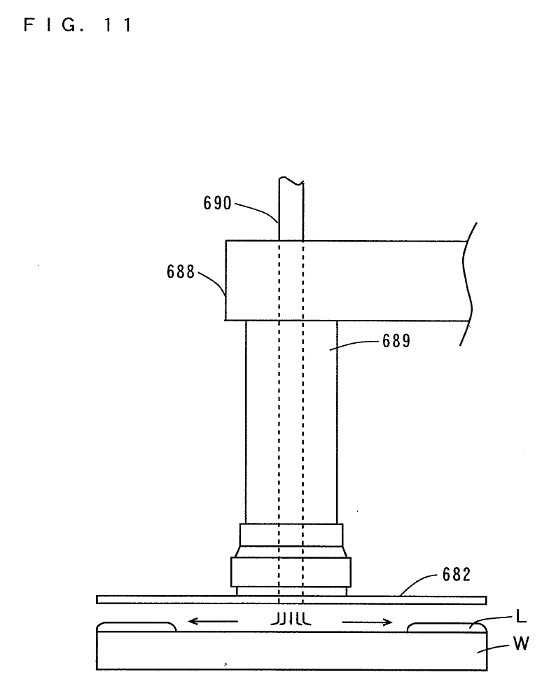

During the drying processing to the substrate W in the drying processing unit DRYa in FIG. 10, with the shield plate 628 brought close to the substrate W as shown in FIG. 11, an inert gas is supplied to clearance between the substrate W and the shield plate 682 from the gas supply passage 690. This allows the inert gas to be efficiently supplied from the center of the substrate W to the peripheral portion thereof, thereby ensuring the removal of the liquid layer L on the substrate W.

Although in the above-described embodiment, the substrate W is subjected to drying processing by spin drying in the drying processing unit DRY, the substrate W may be subjected to drying processing by other methods such as a reduced pressure drying method or an air knife drying method.

Although in the above-described embodiment, the inert gas is supplied from the nozzle 670 with the liquid layer L of the rinse liquid being formed, the following method may be applied when the liquid layer L of the rinse liquid is not formed or the rinse liquid is not used. That is, the liquid layer of cleaning liquid is shaken off once by rotating the substrate W, and an inert gas is then immediately supplied from the nozzle 670 to thoroughly dry the substrate W.

### (1-3d) Effects of Drying Processing Unit

As described above, in the substrate processing apparatus 500 according to the embodiment, the substrate W is subjected to the drying processing by the drying processing group 80 after the exposure processing by the exposure device 15. The liquid attached to the substrate W during the exposure processing is thus removed in the drying processing unit. This prevents a liquid from dropping in the substrate processing apparatus 500 as the substrate W is carried from the drying processing group 80 to the indexer block 9 through the interface block 14, drying processing block 13, development processing block 12, resist film processing block 11 and anti-reflection film processing block 10. As a result, in the substrate processing apparatus 500, operational troubles such as abnormalities in the electric system are prevented.

In addition, the drying processing unit DRY applies the drying processing to the substrate W by spraying the inert gas to the substrate W from the center to the peripheral portion thereof while rotating the substrate W. This reliably removes the cleaning liquid and the rinse liquid on the substrate W, which reliably prevents particles and the like in the atmosphere from attaching to the cleaned substrate W. This prevents contamination of the substrate W reliably while preventing the generation of dry marks on the surface of the substrate W.

In addition, the cleaning liquid and the rinse liquid are reliably prevented from remaining on the cleaned substrate W, so that the resist component are reliably prevented from being eluted in the cleaning liquid and the rinse liquid during the transport of the substrate W from the drying processing unit DRY to the development processing group 70. This prevents the deformation of an exposure pattern formed on the resist film. As a result, the accuracy of line width can be reliably prevented from decreasing during the development processing.

Further, the drying processing unit DRY applies the cleaning processing to the substrate W before the drying processing. Thus, even if a liquid attaches to the substrate during exposure, and particles and the like in the atmosphere adhere to the substrate during the transport of the substrate W from the exposure device 15 to the drying processing unit DRY, the deposits can be reliably removed.

As a result of the foregoing, processing defects of the substrate W are reliably prevented.

Furthermore, since the substrate processing apparatus according to the embodiment has the structure in which the drying processing block 13 is added to an existing substrate processing apparatus, operational troubles of the substrate processing apparatus 500 and contamination of the substrate W are prevented at low cost.

### (1-4) Interface Transport Mechanism

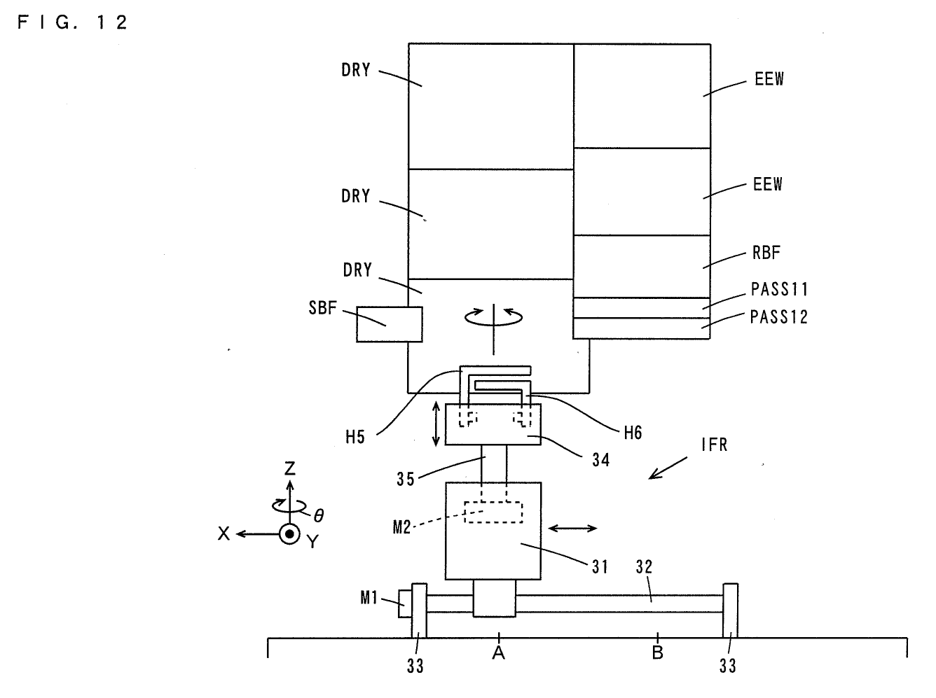

The interface transport mechanism IFR is next described. FIG. 12 is a diagram for use in illustrating the configuration and operation of the interface transport mechanism IFR.

### (1-4a) Configuration and operation of Interface Transport Mechanism

The configuration of the interface transport mechanism IFR is first described. As shown in FIG. 12, a movable base 31 in the interface transport mechanism IFR is threadably mounted to a screwed shaft 22. The screwed shaft 32 is rotatably supported with support bases 33 so as to extend in the X direction. One end of the screwed shaft 32 is provided with a motor M1, which causes the screwed shaft 32 to rotate and the movable base 31 to horizontally move in the ±X direction.

A hand support base 34 is mounted on the movable base 31 so as to rotate in the ±θ direction while moving up and down in the ±Z direction. The hand support base 34 is coupled to a motor M2 in the movable base 31 through a rotation shaft 35, and rotated by the motor M2. Two hands H5, H6 for holding the substrate W in a horizontal attitude are mounted to the hand support base 34 one above the other so as to move forward and backward.

The operation of the interface transport mechanism IFR is next described. The operation of the interface transport mechanism IFR is controlled by the main controller 30 in FIG. 1.

The interface transport mechanism IFR initially rotates the hand support base 34 at the position A in FIG. 12 while lifting the hand support base 34 in the +Z direction, to allow the upper hand H5 to enter the substrate platform PASS9. When the hand H5 has received the substrate W in the substrate platform PASS9, the interface transport mechanism IFR retracts the hand H5 from the substrate platform PASS9, and lowers the hand support base 34 in the −Z direction.

The interface transport mechanism IFR subsequently moves in the −X direction, and rotates the hand support base 34 at the position B while allowing the hand H5 to enter a substrate inlet 15a in the exposure device 15 (see FIG. 1). After the hand H5 has carried the substrate W into the substrate inlet 15a, the interface transport mechanism IFR retracts the hand H5 from the substrate inlet 15a.

Then, the interface transport mechanism IFR allows the hand H6 to enter a substrate outlet 15b in the exposure device 15 (see FIG. 1). When the hand H6 has received the substrate W after the exposure processing from the substrate outlet 15b, the interface transport mechanism IFR retracts the hand H6 from the substrate outlet 15b.

After this, the interface transport mechanism IFR moves in the +X direction, and rotates the hand support base 34 at the position A while lifting the hand support base 24 in the +Z direction, to allow the hand H6 to enter the drying processing units DRY in the drying processing group 80. After the hand 6 has carried the substrate W into a drying processing unit DRY, the interface transport mechanism IFR retracts the hand H6 from the drying processing unit DRY.

Then, the interface transport mechanism IFR allows the hand H5 to enter the drying processing unit DRY, then the hand H5 receives the substrate W therefrom. After this, the interface transport mechanism IFR retracts the hand H5 from the drying processing unit DRY.

The interface transport mechanism IFR then lifts or lowers the hand support base 34 in the ±Z direction while rotating the hand support base 34, to allow the hand H5 to enter the substrate platform PASS12, and transfer the substrate W therein.

If the exposure device 15 is not capable of receiving the substrate W during the transport of the substrate W from the substrate platform PASS11 to the exposure device 15, the substrate W is transported to the buffer SBF once, and wait there until the exposure device 15 becomes capable of receiving the substrate W.

Also, if the drying processing group 80 is not capable of receiving the substrate W during the transport of the substrate W from the exposure device 15 to the drying processing group 80, the substrate W is transported to the return buffer unit RBF2 once, and wait until the drying processing group 80 becomes capable of receiving the substrate W.

### (1-4b) Effects of Interface Transport Mechanism

As described above, in this embodiment, the hand H5 of the interface transport mechanism IFR is used during the transport of the substrate W from the substrate platform PASS11 to the exposure device 15 and from the drying processing group 80 to the substrate platform PASS12, while the hand H6 is used during the transport of the substrate W from the exposure device 15 to the drying processing group 80. That is, the hand H6 is used for transporting the substrate W to which a liquid is attached after the exposure processing, while the hand H5 is used for transporting the substrate W to which no liquid is attached before the exposure processing. This prevents the liquid on the substrate W from attaching to the hand H5.

Moreover, since the hand H6 is arranged below the hand H5, even if a liquid drops from the hand H6 and the substrate W held thereon, the liquid will not attach to the hand H5 and the substrate W held thereon.

As a result of the foregoing, the liquid is reliably prevented from attaching to the substrate W after the drying processing, so that operational troubles of the substrate processing apparatus 500 due to drops of liquid in the substrate processing apparatus 500 are more reliably prevented.

Moreover, a liquid is prevented from attaching to the substrate W before the exposure processing, which prevents particles and the like in the atmosphere from attaching to the substrate W before the exposure processing. This prevents the contamination in the exposure device 15, so that processing defects of the substrate W in the exposure device 15 are reduced.

### (1-4c) Modifications of First Embodiment

In this embodiment, the substrates W are transported from the substrate platform PASS11 to the exposure device 15, from the exposure device 15 to the drying processing group 80, and from the drying processing group 80 to the substrate platform PASS12 by the single interface transport mechanism IFR. However, the substrates W may also be carried using a plurality of interface transport mechanisms.

In addition, the operation and configuration of the interface transport mechanism IFR may be modified according to the positions of the substrate inlet 15a and the substrate outlet 15b in the exposure device 15. For example, when the substrate inlet 15a and the substrate outlet 15b in the exposure device 15 are positioned opposite to position A in FIG. 12, the screwed shaft 32 in FIG. 12 may be omitted.

### (2) Second Embodiment

### (2-1) Drying Processing Unit Using Two-Fluid Nozzle

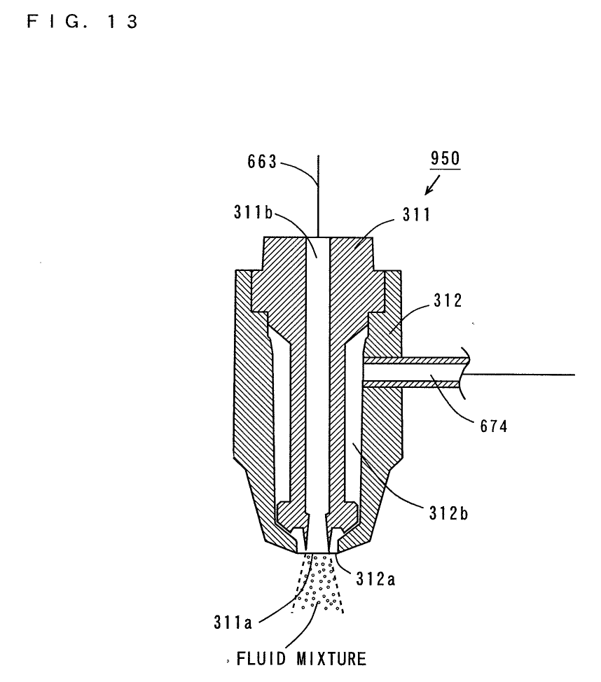

A substrate processing apparatus according to a second embodiment is different from the substrate processing apparatus according to the first embodiment in using a two-fluid nozzle shown in FIG. 13 in the drying processing unit DRY, instead of the nozzle 650 for cleaning processing and the nozzle 670 for drying processing in FIG. 4. The configuration of the substrate processing apparatus according to the second embodiment is otherwise similar to that of the substrate processing apparatus according to the first embodiment.

FIG. 13 is a longitudinal cross section showing an example of the internal structure of the two-fluid nozzle 950 for use in cleaning and drying processings. The two-fluid nozzle 950 is capable of selectively discharging a gas, a liquid, and a fluid mixture of the gas and liquid.

The two-fluid nozzle 950 in this embodiment is so-called an external-mix type. The external-mix type two-fluid nozzle 950 shown in FIG. 13 comprises an inner body portion 311 and an outer body portion 312. The inner body portion 311 is composed of quartz or the like, and the outer body portion 312 is composed of a fluororesin such as PTFE (polytetrafluoroethylene).

A liquid passage 311b is formed along the central axis of the inner body portion 311. The liquid passage 311b is provided with the supply pipe 663 shown in FIG. 4 for cleaning processing. Cleaning liquid or rinse liquid supplied from the supply pipe 663 is thus introduced into the liquid passage 311b.

A liquid discharge port 311a that communicates with the liquid passage 311b is formed at a lower end of the inner body portion 311. The inner body portion 311 is inserted into the outer body portion 312. Upper ends of the inner body portion 311 and the outer body portion 312 are joined together, while lower ends thereof are not joined.

A cylindrical gas passage 312b is formed between the inner body portion 311 and the outer body portion 312. A gas discharge port 312a that communicates with the gas passage 312b is formed at the lower end of the outer body portion 312. The supply pipe 674 shown in FIG. 4 for drying processing is mounted to a peripheral wall of the outer body portion 312, so as to communicate with the gas passage 312b. An inert gas supplied from the supply pipe 674 is thus introduced into the gas passage 312b.

The diameter of the gas passage 312 decreases downward in the vicinity of the gas discharge port 312a. As a result, the velocity of flow of the inert gas is accelerated, and the inert gas is discharged from the gas discharge port 312a.

The cleaning liquid discharged from the liquid discharge port 311a and the inert gas discharged from the gas discharge port 312a are mixed outside near the lower end of the two-fluid nozzle 950 to generate a mist-like fluid mixture that contains fine droplets of the cleaning liquid.

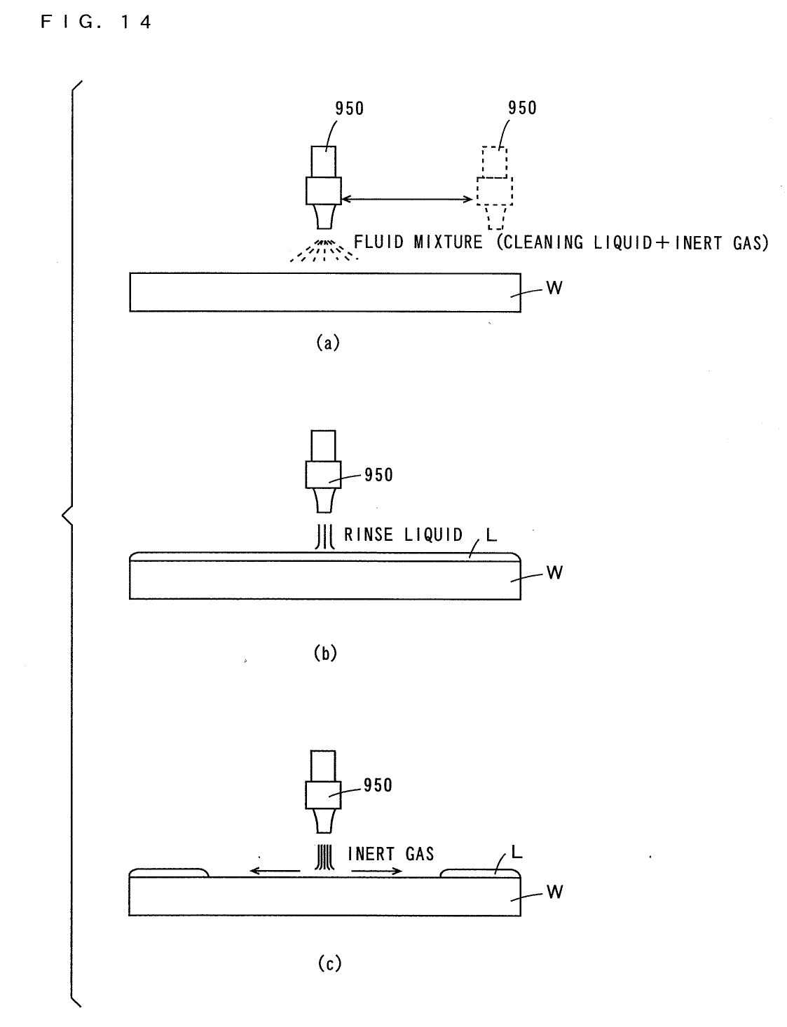

FIGS. 14(a), 14(b), 14(c) are diagrams for use in illustrating a method of applying drying processing to the substrate W using the two-fluid nozzle 950 in FIG. 13.

The substrate W is initially held on the spin chuck 621 by suction, as shown in FIG. 4, and rotates together with the rotation of the rotation shaft 625. The rotation speed of the rotation shaft 625 is, e.g., about 500 rpm.

In this state, as shown in FIG. 14(a), the two-fluid nozzle 950 discharges the mist-like fluid mixture of the cleaning liquid and the inert gas onto the top surface of the substrate W while gradually moving from above the center of the substrate W to above the peripheral portion thereof. In this way, the fluid mixture is sprayed onto the entire surface of the substrate W from the two-fluid nozzle 950 to clean the substrate W.

Since the fluid mixture discharged from the two-fluid nozzle 950 contains fine droplets of the cleaning liquid, any contaminants attached on the surface of the substrate W can be stripped off, even if the surface has irregularities. The contaminants on the surface of the substrate W can thus be reliably removed. Moreover, even if the films on the substrate W have low wettability, the fine droplets of the cleaning liquid strip off the contaminants on the surface of the substrate W, so that the contaminants can be reliably removed from the surface of the substrate W.

In addition, adjusting the flow rate of the inert gas makes it easy to adjust the detergency in cleaning the substrate W. Thus, when the organic films (i.e., a resist film and a resist cover film) on the substrate W are prone to damage, damage to the organic films on the substrate W can be prevented by weakening the detergency. Tough contaminants on the surface of the substrate W can also be removed reliably by strengthening the detergency. By adjusting the detergency in this way according to the properties of the organic films on the substrate W and the degree of contamination, it is possible to prevent damage to the organic films on the substrate W and the substrate W is cleaned reliably.

Next, the supply of the fluid mixture is stopped, and the rotation speed of the rotation shaft 625 decreases while the rinse liquid is discharged from the two-fluid nozzle 960 onto the substrate W, as shown in FIG. 14(b). The rotation speed of the rotation shaft 625 is, e.g., about 10 rpm. A liquid layer L of the rinse liquid is thus formed on the entire surface of the substrate W. Alternatively, the rotation of the rotation shaft 625 may be stopped to form the liquid layer L on the entire surface of the substrate W. When pure water is used as the cleaning liquid in the fluid mixture for cleaning the substrate W, the supply of the rinse liquid may be omitted.

After the formation of the liquid layer L, the supply of the rinse liquid is stopped. Then, the inert gas is discharged onto the substrate W from the two-fluid nozzle 950, as shown in FIG. 14(c). This causes the cleaning liquid on the center of the substrate W to move to the peripheral portion of the substrate W, leaving the liquid layer L only on the peripheral portion.

Then, the rotation speed of the rotation shaft 625 increases. The rotation speed of the rotation shaft 625 is, e.g., about 100 rpm. This causes a great centrifugal force acting on the liquid layer L on the substrate W, allowing the removal of the liquid layer L on the substrate W. As a result, the substrate W is dried.

The two-fluid nozzle 950 may gradually move from above the center of the substrate W to above the peripheral portion thereof when removing the liquid layer L on the substrate W. This allows the inert gas to be sprayed to the entire surface of the substrate W, which ensures the removal of the liquid layer L on the substrate W. As a result, the substrate W can be reliably dried.

### (2-2) Other Example of Drying Processing Unit Using Two-Fluid Nozzle

Although the two-fluid nozzle 950 in FIG. 13 is used to supply the rinse liquid to the substrate W, a separate nozzle may also be used for supplying the rinse liquid to the substrate W.

Moreover, although the two-fluid nozzle 950 in FIG. 13 is used to supply the inert gas to the substrate W when removing the liquid layer L on the substrate W, a separate nozzle may also be used for supplying the inert gas to the substrate W.

### (2-3) Effects of Second Embodiment

In the substrate processing apparatus 500 according to the second embodiment, the drying processing unit DRY applies the cleaning processing to the substrate W after the exposure processing by the exposure device 15. In this case, the residual droplets attached on the substrate W after the exposure processing, the eluate from the organic films on the substrate, and the like are removed by supplying the fluid mixture of the cleaning liquid and the inert gas from the two-fluid nozzle 950 in the drying processing unit DRY.

Since the fluid mixture discharged from the two-fluid nozzle 950 contains fine droplets of the cleaning liquid, the contaminants attached on the surface of the substrate W is removed by the fine droplets of the cleaning liquid, even if the surface of the substrate W has irregularities. The contaminants on the surface of the substrate W is thus reliably removed. Moreover, even if the films on the substrate W have low wettability, the fine droplets of the cleaning liquid remove the contaminants on the surface of the substrate W, so that the contaminants can be reliably removed from the surface of the substrate W. As a result of the foregoing, processing defects of the substrate due to the contamination after the exposure processing are prevented.

In addition, adjusting the flow rate of the inert gas makes it easy to adjust the detergency in cleaning the substrate W. Accordingly, when the organic films on the substrate (i.e, resist film and resist cover film) are prone to damage, damage to the organic films on the substrate W can be prevented by weakening the detergency. Tough contaminants on the surface of the substrate W can also be removed reliably by strengthening the detergency. By adjusting the detergency in this way according to the properties of the organic films on the substrate W and the degree of contamination, it is possible to prevent damage to the organic films on the substrate W and the substrate W is cleaned reliably.

Moreover, the drying processing unit DRY applies the drying processing to the substrate W after the cleaning processing. This removes the cleaning liquid supplied onto the substrate W, thus preventing the cleaning liquid from dropping in the substrate processing apparatus 500 as the substrate W is carried from the drying processing group 80 to the indexer block 9 through the interface block 14, drying processing block 13, development processing block 12, resist film processing block 11, and anti-reflection film processing block 10. As a result, in the substrate processing apparatus 500, operational troubles such as abnormalities in the electric system are prevented.

Furthermore, the drying processing unit DRY applies the drying processing to the substrate W by spraying the inert gas to the substrate W from the center to the peripheral portion thereof while rotating the substrate W. This reliably removes the cleaning liquid and the rinse liquid on the substrate W, which prevents particles and the like in the atmosphere from attaching to the cleaned substrate W. This prevents contamination of the substrate W reliably while preventing the generation of dry marks on the surface of the substrate W.

Furthermore, the cleaning liquid and the rinse liquid are reliably prevented from remaining on the cleaned substrate W, so that the resist component are reliably prevented from being eluted in the cleaning liquid and the rinse liquid during the transport of the substrate W from the drying processing unit DRY to the development processing group 70. This prevents the deformation of an exposure pattern formed on the resist film. As a result, the accuracy of line width can be reliably prevented from decreasing during the development processing.

As a result of the foregoing, processing defects of the substrate W are prevented.

In the second embodiment, the external-mix type two-fluid nozzle 950 is used. This external-mix type two-fluid nozzle 950 generates the fluid mixture by mixing the cleaning liquid and the inert gas outside the two-fluid nozzle 950. The inert gas and the cleaning liquid flow through the separate flow passages, respectively, in the two-fluid nozzle 950. This prevents the cleaning liquid from remaining in the gas passage 312b, allowing the inert gas to be discharged independently from the two-fluid nozzle 950. Also, the rinse liquid can be discharged independently from the two-fluid nozzle 950 by supplying the rinse liquid from the supply pipe 663. This allows the fluid mixture, the inert gas, and the rinse liquid to be selectively discharged from the two-fluid nozzle 950.

Furthermore, the use of the two-fluid nozzle 950 obviates the need to provide nozzles for supplying the cleaning liquid or the rinse liquid to the substrate W and for supplying the inert gas to the substrate W separately. This provides reliable cleaning and drying of the substrate W with a simple structure.

Furthermore, since the substrate processing apparatus according to the embodiment has the structure in which the drying processing block 13 is added to an existing substrate processing apparatus, operational troubles of the substrate processing apparatus 500 and contamination of the substrate W are prevented at low cost.

### (3) Correspondence Between Each Claim Element and Each Component in Embodiments

In the embodiments, each of the anti-reflection film processing block 10, the resist film processing block 11, the development processing block 12, and the drying processing block 13 corresponds to a processing section; the interface block 14 corresponds to an interface; the coating unit RES corresponds to a first processing unit; the resist film processing block 11 corresponds to a first processing block; each of the drying processing units DRY, DRYa corresponds to a second processing unit; the drying processing block 13 corresponds to a second processing block; the development processing units DEV corresponds to a third processing unit; the development processing block 12 corresponds to a third processing block; the coating unit BARC corresponds to a fourth processing unit; the anti-reflection film processing block 10 corresponds to a fourth processing block; and the indexer block 9 corresponds to a indexer.

The heating unit HP and the cooling unit CP correspond to first to fourth thermal processing units; the second central robot CR2 corresponds to a first transport unit; the fourth transport robot CR4 corresponds to a second transport unit; the third transport robot CR3 corresponds to a third transport unit; the first transport robot CR1 corresponds to a fourth transport unit; the fifth transport robot CR5 corresponds to a fifth transport unit; the interface transport mechanism IFR corresponds to a sixth transport unit; the hand H5 corresponds to a first holder; the hand H6 corresponds to a second holder; and the each of the substrate platforms PASS11, PASS12 correspond to a platform.

The spin chuck 621 corresponds to a substrate holding device; the rotation shaft 625 and the chuck rotation-drive mechanism 636 correspond to a rotation-driving device; the nozzle 650 for cleaning processing corresponds to a cleaning liquid supplier and a rinse liquid supplier; and each of the nozzles 670, 770, 870 for drying processing corresponds to an inert gas supplier.

The two-fluid nozzle 950 corresponds to a fluid nozzle; the liquid passage 311b corresponds to a liquid flow passage; and the gas passage 312b corresponds to a gas flow passage.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of processing a substrate in a substrate processing apparatus that is arranged adjacent to an exposure device and includes first, second and third processing units, comprising the steps of:
forming a film made of a photosensitive material on the substrate by said first processing unit before exposure processing by said exposure device;
applying drying processing to the substrate by said second processing unit after the exposure processing by said exposure device; and
applying development processing to the substrate by said third processing unit after the drying processing by said second processing unit.

2. The substrate processing method according to claim 1, wherein
said step of applying the drying processing to the substrate includes the step of supplying an inert gas onto the substrate.

3. The substrate processing method according to claim 1, further comprising the step of applying cleaning processing to the substrate in said second processing unit after the exposure processing by said exposure device and before the drying processing by said second processing unit.

4. The substrate processing method according to claim 3, wherein
said step of applying the cleaning processing to the substrate includes the step of supplying a cleaning liquid onto the substrate, and
said step of applying the drying processing to the substrate includes the steps of:
rotating the substrate, onto which the cleaning liquid is supplied, about an axis vertical to the substrate while holding the substrate substantially horizontally, and
supplying an inert gas onto the substrate being rotated.

5. The substrate processing method according to claim 4, wherein
said step of supplying the inert gas includes the step of supplying the inert gas so that the cleaning liquid supplied onto the substrate is removed from the substrate as the cleaning liquid moves outwardly from the center of the substrate.

6. The substrate processing method according to claim 4, wherein
said step of applying the drying processing to the substrate further includes the step of supplying a rinse liquid onto the substrate after the supply of the cleaning liquid and before the supply of the inert gas.

7. The substrate processing method according to claim 6, wherein
said step of supplying the inert gas includes the step of supplying the inert gas so that the rinse liquid supplied onto the substrate is removed from the substrate as the rinse liquid moves outwardly frame the center of the substrate.

8. The substrate processing method according to claim 1, further comprising the steps of:
transporting the substrate after the formation of said photosensitive film to said exposure device, and
transporting the substrate from said exposure device.

9. The substrate processing method according to claim 8, wherein
said substrate processing apparatus further comprises a first transport unit including first and second holders,
said step of transporting the substrate to said exposure device includes the step of holding and transporting the substrate to said exposure device with said first holder of said first transport unit, and
said step of transporting the substrate from said exposure device includes the step of holding and transporting the substrate from said exposure device to said second processing unit with said second holder of said first transport unit.

10. The substrate processing method according to claim 9, wherein
said step of transporting the substrate from said exposure device to said second processing unit includes the step of holding and transporting the substrate with said second holder that is provided below said first holder.

11. The substrate processing method according to claim 9, wherein
said substrate processing apparatus further includes a second transport unit and a platform,
said method further comprises the step of transporting the substrate after the formation of said photosensitive film and before the exposure processing by said exposure device to said platform by said second transport unit, and
said step of transporting the substrate to said exposure device includes the step of holding and transporting the substrate before the exposure processing, mounted on said platform to said exposure device, with said first holder of said first transport unit.

12. The substrate processing method according to claim 11, further comprising the steps of:
holding and transporting the substrate after the drying processing by said second processing unit from said second processing unit to said platform, with said first holder of said first transport unit, and
transporting the substrate, after the exposure processing, mounted on said platform, by said second transport unit.

13. The substrate processing method according to claim 11, wherein
said substrate processing apparatus further includes a fourth processing unit, and
said step of transporting the substrate to said platform by said second transport unit includes the steps of:
transporting the substrate to said fourth processing unit by said second transport unit,
applying given processing to the substrate transported by said second transport unit, by said fourth processing unit, and
transporting the substrate from said fourth processing unit to said platform by said second transport unit.

14. The substrate processing method according to claim 13, wherein
said step of applying the given processing by said fourth processing unit includes the step of subjecting a peripheral portion of the substrate to exposure by said fourth processing unit.

15. The substrate processing method according to claim 1, wherein
said substrate processing apparatus further includes a fifth processing unit, and
said method further comprises the step of forming an anti-reflection film by said fifth processing unit on the substrate before the formation of said photosensitive film by said first processing unit.

16. A method of processing a substrate in a substrate processing apparatus that is arranged adjacent to an exposure device and includes first, second and third processing units, comprising the steps of:
forming a photosensitive film made of a photosensitive material on the substrate by said first processing unit before exposure processing by said exposure device;
applying cleaning processing to the substrate by supplying a fluid mixture containing a liquid and a gas from a fluid nozzle to the substrate in said second processing unit after the exposure processing by said exposure device; and
applying development processing to the substrate by said third processing unit after the cleaning processing by said second processing unit.

17. The substrate processing method according to claim 16, further comprising the step of applying drying processing to the substrate by said second processing unit after the cleaning processing by said second processing unit.

18. The substrate processing method according to claim 17, wherein
said step of applying the drying processing to the substrate includes the step of supplying an inert gas onto the substrate.

19. The substrate processing method according to claim 18, wherein
said step of supplying the inert gas onto the substrate includes the step of supplying the inert gas from said fluid nozzle onto the substrate.

20. The substrate processing method according to claim 17, wherein
said step of applying the drying processing to the substrate includes the steps of:
rotating the substrate, onto which the fluid mixture is supplied, about an axis vertical to the substrate while holding the substrate substantially horizontally, and supplying an inert gas onto the substrate being rotated.

21. The substrate processing method according to claim 20, wherein
said step of supplying the inert gas includes the step of supplying the inert gas so that the fluid mixture supplied onto the substrate is removed from the substrate as the fluid mixture moves outwardly from the center of the substrate.

22. The substrate processing method according to claim 20, wherein
said step of applying the drying processing to the substrate further includes the step of supplying a rinse liquid onto the substrate after the supply of the fluid mixture and before the supply of the inert gas.

23. The substrate processing method according to claim 22, wherein
said step of supplying the rinse liquid onto the substrate includes the step of supplying the rinse liquid from said fluid nozzle onto the substrate.

24. The substrate processing method according to claim 23, wherein
said step of supplying the inert gas includes the step of supplying the inert gas so that the rinse liquid supplied onto the substrate is removed from the substrate as the rinse liquid moves outwardly from the center of the substrate.
